(19) United States
(12) Patent Application Publication
(10) Pub. No.: US 2017/0254652 A1
(43) Pub. Date: Sep. 7, 2017

(54) ELECTRONIC APPARATUS AND CONTROL METHOD OF ELECTRONIC APPARATUS

(71) Applicant: KYOCERA CORPORATION, Kyoto (JP)

(72) Inventor: Natsuhito HONDA, Yokohama-shi (JP)

(21) Appl. No.: 15/604,359

(22) Filed: May 24, 2017

Related U.S. Application Data
(63) Continuation of application No. PCT/JP2015/083011, filed on Nov. 25, 2015.

(30) Foreign Application Priority Data
Nov. 27, 2014 (JP) 2014-240572
Nov. 27, 2014 (JP) 2014-240573

(51) Int. Cl. G01C 21/34; G01C 22/00; G09B 29/10

(52) U.S. Cl. CPC G01C 21/34; G09B 29/106; G01C 22/006

(57) ABSTRACT

An electronic apparatus comprises a wireless communication unit, a display, a position acquiring unit, and at least one processor. The position acquiring unit obtains a position information of the electronic apparatus based on a signal received by the wireless communication unit. The processor generates a whole route along which a user has moved while distinguishing between first and second section routes. The first section route is a route in which an acquisition accuracy of the position information is lower than a reference value. The processor obtains a distance between starting and ending points of the first section route based on an information different from a position information. The processor generates a candidate section route, which is different from the first section route, for connecting the starting and ending points based on the distance. The processor displays the first and second section routes, and the candidate section route on the display.

### CROSS-REFERENCE TO RELATED APPLICATION

The present application is a continuation based on PCT Application No. PCT/JP2015/083011, filed on Nov. 25, 2015, which claims the benefit of Japanese Application No. 2014-240572, filed on Nov. 27, 2014 and Japanese Application No. 2014-240573, filed on Nov. 27, 2014. PCT Application No. PCT/JP2015/083011 is entitled “ELECTRONIC APPARATUS” and both Japanese Application No. 2014-240572 and 2014-240573 are entitled “ELECTRONIC DEVICE”. The contents of which are incorporated by reference herein in their entirety.

### FIELD

Embodiments of the present disclosure relate to an electronic apparatus and a control method thereof.

### BACKGROUND

An apparatus which obtains and stores a route along which a user has moved is well-known.

### SUMMARY

An electronic apparatus and a control method are disclosed. In one embodiment, an electronic apparatus comprises a wireless communication unit, a display, a position acquiring unit, and at least one processor. The position acquiring unit obtains a position information of the electronic apparatus based on a received signal received by the wireless communication unit. The at least one processor generates a whole route along which a user has moved based on a plurality of position information while distinguishing between a first section route and a second section route other than the first section route. The first section route is a route in which an acquisition accuracy of the position information is lower than a reference value. The at least one processor obtains a section distance from a starting point to an ending point of the first section route based on a predetermined information different from a position information. The at least one processor generates a candidate section route, which is different from the first section route, for connecting the starting point and the ending point of the first section route based on the section distance. The at least one processor displays the first section route, the second section route, and the candidate section route on the display.

In one embodiment, an electronic apparatus comprises a wireless communication unit, a display, a position acquiring unit, and at least one processor. The position acquiring unit obtains a position information of the electronic apparatus based on a received signal received by the wireless communication unit. The at least one processor generates a route information indicating a whole route along which a user has moved based on a plurality of position information. The at least one processor calculates a first whole distance which is a whole distance of the whole route based on the route information. The at least one processor obtains a second whole distance which is a whole distance of the whole route based on a predetermined information different from a position information, and obtains a candidate whole route, which is different from the whole route, for connecting a starting point and an ending point of the whole route based on the second whole distance when a difference between the first whole distance and the second whole distance is larger than a predetermined value. The at least one processor displays the whole route and the candidate whole route on the display.

In one embodiment, in a control method of an electronic apparatus, a position information of the electronic apparatus is obtained based on a received signal received by a wireless communication unit. In the control method, a whole route along which a user has moved is generated based on a plurality of position information while distinguishing between a first section route and a second section route other than the first section route. The first section route is a route in which an acquisition accuracy of the position information is lower than a reference value. In the control method, a section distance from a starting point to an ending point of the first section route is obtained based on a predetermined information different from a position information and a candidate section route, which is different from the first section route, for connecting the starting point and the ending point of the first section route is generated based on the section distance. In the control method, the first section route, the second section route, and the candidate section route are displayed on the display.

### BRIEF DESCRIPTION OF THE DRAWINGS

FIG. 1 illustrates a front view schematically showing one example of an external appearance of an electronic apparatus.

FIG. 2 illustrates a rear view schematically showing one example of the external appearance of the electronic apparatus.

FIG. 3 illustrates a view schematically showing one example of an internal configuration of the electronic apparatus.

FIG. 4 is a view schematically showing one example of a controller.

FIG. 5 is a flow chart showing one example of an operation of the controller.

FIG. 6 is a view schematically showing one example of a screen of a display.

FIG. 7 is a view schematically showing one example of the screen of the display.

FIG. 8 is a flow chart showing one example of the operation of the controller.

FIG. 9 is a view schematically showing one example of the screen of the display.

FIG. 10 is a flow chart showing one example of an operation of a route correction unit.

FIG. 11 is a view schematically showing one example of the screen of the display.

FIG. 12 is a view schematically showing one example of the screen of the display.

FIG. 13 is a view schematically showing one example of the controller.

FIG. 14 is a flow chart showing one example of the operation of the controller.

FIG. 15 is a flow chart showing one example of the operation of the controller.

FIG. 16 is a view schematically showing one example of the screen of the display.

FIG. 17 is a flow chart showing one example of an operation of a display controller.

FIG. 18 is a view schematically showing one example of the screen of the display.

FIG. 19 is a flow chart showing one example of the operation of the route correction unit.

FIG. 20 is a view schematically showing one example of the screen of the display.

FIG. 21 is a view schematically showing one example of the screen of the display.

FIG. 22 is a view schematically showing one example of the screen of the display.

FIG. 23 is a flow chart showing one example of the operation of the display controller.

FIG. 24 is a view schematically showing one example of the screen of the display.

FIG. 25 is a view schematically showing one example of the screen of the display.

FIG. 26 is a view schematically showing one example of the screen of the display.

FIG. 27 is a view schematically showing one example of the screen of the display.

FIG. 28 is a view schematically showing one example of the screen of the display.

FIG. 29 illustrates a view schematically showing one example of an electrical internal configuration of the electronic apparatus.

FIG. 30 is a flow chart showing one example of the operation of the controller.

### DETAILED DESCRIPTION

### First Embodiment

<1. Electronic Apparatus>

<1-1. External Appearance>

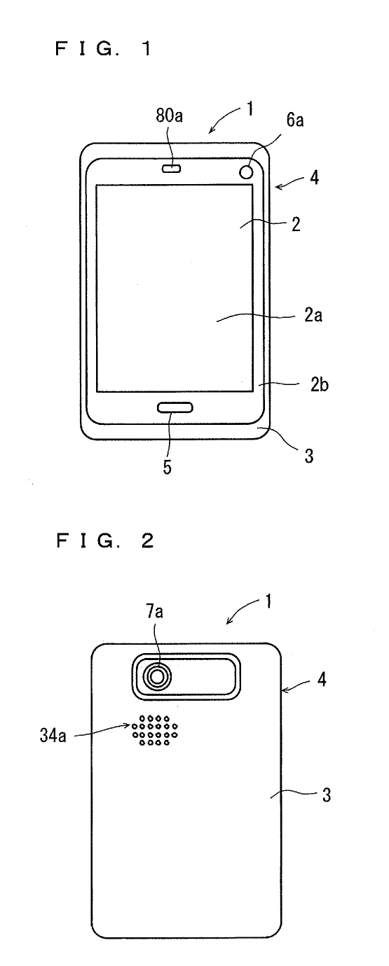

FIG. 1 illustrates a front view schematically showing one example of an external appearance of an electronic apparatus 1. FIG. 2 illustrates a rear view schematically showing one example of the external appearance of the electronic apparatus 1. The electronic apparatus 1 is, for example, a tablet, a PDA (Personal Digital Assistant), or a mobile phone (including a smartphone). The electronic apparatus 1 can communicate with another communication apparatus directly or via, for example, a base station and a server.

As illustrated in FIGS. 1 and 2, the electronic apparatus 1 includes a cover panel 2 and a case portion 3, and a combination of the cover panel 2 and the case portion 3 forms a housing (hereinafter may also be referred to as an apparatus case) 4 having a substantially rectangular plate-like shape in plane view.

The cover panel 2 has a substantially rectangular shape in plane view and forms a front portion of the electronic apparatus 1 except for a peripheral portion of the front portion of the electronic apparatus 1. The cover panel 2 is made of, for example, a transparent glass or a transparent acrylic resin. Alternatively, the cover panel 2 is made of, for example, sapphire. Here, sapphire refers to a monocrystal that contains alumina (Al₂O₃) as a main component, and herein, refers to a monocrystal having a purity of Al₂O₃ of approximately 90% or more. The purity of Al₂O₃ is preferably greater than or equal to 99% in order to further increase resistance to scratches. In addition, examples of materials for the cover panel 2 include diamond, zirconia, titania, crystal, lithium tantalite, and aluminum oxynitride. These materials are also preferably a monocrystal having a purity of greater than or equal to approximately 90% in order to further increase resistance to scratches.

The cover panel 2 may be a composite panel (laminated panel) of a multilayer structure that includes the layer of sapphire. For example, the cover panel 2 may be a composite panel of a two-layer structure that includes a layer of sapphire (sapphire panel) located on the surface of the electronic apparatus 1 and a layer of glass (glass panel) attached to the layer of sapphire. The cover panel 2 may be a composite panel of a three-layer structure that includes the layer of sapphire (sapphire panel) located on the surface of the electronic apparatus 1, the layer of glass (glass panel) attached to the layer of sapphire, and a layer of sapphire (sapphire panel) attached to the layer of glass. The cover panel 2 may include a layer made of crystalline materials, except for sapphire, such as diamond, zirconia, titania, crystal, lithium tantalite, and aluminum oxynitride.

The case portion 3 forms the peripheral portion of the front portion, the side portion, and the back portion of the electronic apparatus 1. The case portion 3 is made of, for example, a polycarbonate resin.

A display area 2a on which various pieces of information such as characters, symbols, graphics, and images are displayed is located on a front surface of the cover panel 2. The display area 2a has, for example, a rectangular shape in plane view. A peripheral portion 2b of the cover panel 2 that surrounds the display area 2a is opaque and/or not transparent because of, for example, a film or the like that is attached thereto, and is a non-display portion that does not transmit a display of the information. A touch panel 50, which will be described below, is located on a rear surface of the cover panel 2. The user can accordingly provide various instructions to the electronic apparatus 1 by operating the display area 2a on the front surface of the electronic apparatus 1 with a finger or the like. The user can also provide various instructions to the electronic apparatus 1 by operating the display area 2a with, for example, a pen for capacitive touch panel such as a stylus pen instead of the operator such as the finger.

For example, an operation key 5 is located in the apparatus case 4. The operation key 5 is, for example, a hardware key and is located on, for example, a lower-side end portion of the front surface of the cover panel 2.

The touch panel 50 and the operation key 5 are operation units for performing an operation on the electronic apparatus 1.

<1-2. Electrical Configuration of Electronic Apparatus>

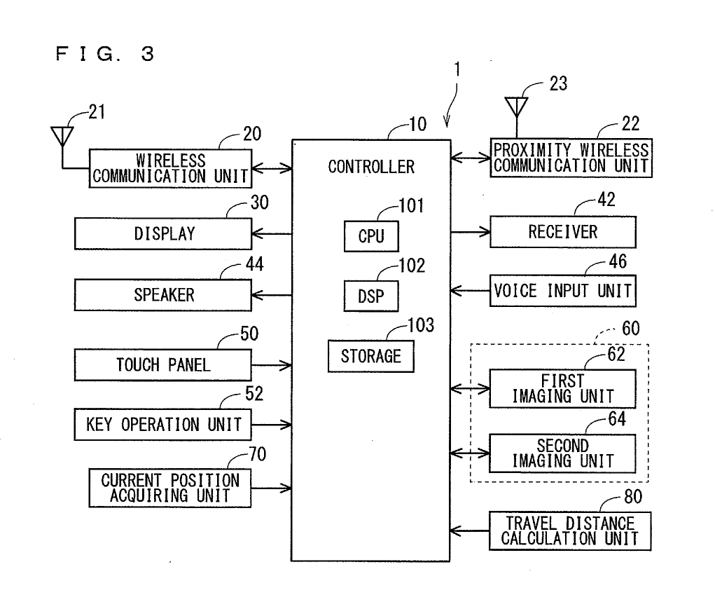

FIG. 3 illustrates a view schematically showing one example of an electrical internal configuration of the electronic apparatus 1. As illustrated in FIG. 3, the electronic apparatus 1 includes a controller 10, a wireless communication unit 20, a proximity wireless communication unit 22, a display 30, a receiver 42, a speaker 44, a voice input unit 46, the touch panel 50, a key operation unit 52, an imaging unit 60, a current position acquiring unit 70, and a travel distance calculation unit 80. The apparatus case 4 accommodates these structural components of the electronic apparatus 1.

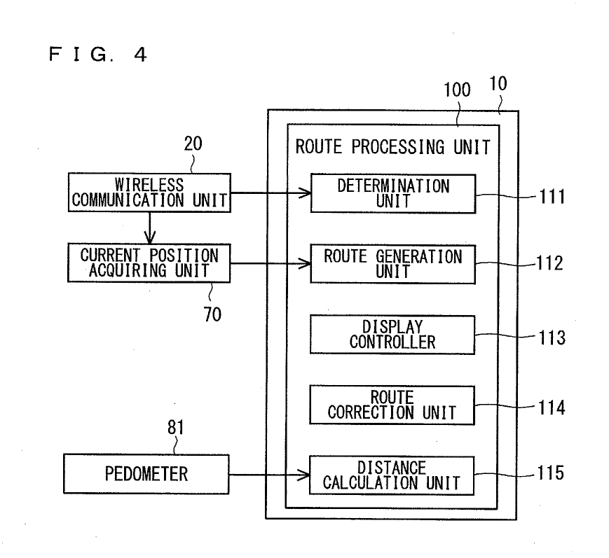

The controller 10 includes a CPU (Central Processing Unit) 101, a DSP (Digital Signal Processor) 102, and a storage 103, for example. The controller 10 can manage the overall operation of the electronic apparatus 1 by controlling the other structural components of the electronic apparatus 1. The storage 103 includes a ROM (Read Only Memory) and a RAM (Random Access Memory), for example. A main program, a plurality of application programs (hereinafter may simply be referred to as “applications”), and the like are stored in the storage 103, the main program being a control program for controlling the operation of the electronic apparatus 1, specifically, for controlling the respective structural components such as the wireless communication unit 20 and the display 30 of the electronic apparatus 1. Various functions of the controller 10 can be achieved by the CPU 101 and the DSP 102 executing various programs in the storage 103. FIG. 4 illustrates one CPU 101 and one DSP 102 that may comprise a plurality of CPUs 101 and DSPs 102. They may cooperate with each other to achieve the various functions. The storage 103, which is illustrated inside the controller 10 in FIG. 4, may be located outside the controller 10. In other words, the storage 103 and the controller 10 may be formed separately. Part or all of the functions of the controller 10 may be achieved by the hardware.

The wireless communication unit 20 includes an antenna 21. In the wireless communication unit 20, the antenna 21 can receive a signal, via a base station, for example, from a mobile phone different from the electronic apparatus 1, or from a communication apparatus such as a web server connected to Internet. The wireless communication unit 20 can perform an amplification processing and down conversion on the received signal and output the signal to the controller 10. The controller 10 can perform a demodulation processing or the like on the input received signal. The wireless communication unit 20 can perform up-converting and the amplification processing on a transmission signal generated in the controller 10, and wirelessly transmit the transmission signal after the processing from the antenna 21. The transmission signal from the antenna 21 can be received in a mobile phone different from the electronic apparatus 1 or a communication apparatus connected to the Internet via the base station, for example.

The wireless communication unit 20 can also receive a signal from a satellite via the antenna 21. The signal from the satellite is used in the current position acquiring unit 70.

The proximity wireless communication unit 22 includes an antenna 23. The proximity wireless communication unit 22 can communicate with, via the antennal 23, a communication terminal located closer thereto than an object of communication (for example, a base station) of the wireless communication unit 20 is. The proximity wireless communication unit 22 performs communication in conformity with, for example, BLUETOOTH (registered trademark) standards.

The display 30 is, for example, a liquid crystal panel or an organic electroluminescent (EL) panel. The display 30 can display various pieces of information such as characters, symbols, graphics, and images by control of the controller 10. The information displayed on the display 30 is displayed in the display area 2a on the front surface of the cover panel 2. It can thus be said that the display 30 performs the display in the display area 2a.

The touch panel 50 can detect an operation performed on the display area 2a of the cover panel 2 by an operator such as an operating finger. The touch panel 50 is, for example, a projected capacitive touch panel, and is attached to the rear surface of the cover panel 2. When the user operates the display area 2a of the cover panel 2 by the operator such as the operating finger, the controller 10 receives a signal in response to the operation from the touch panel 50. The controller 10 can specify the contents of the operation performed on the display area 2a based on the signal from the touch panel 50 and perform a processing according to the screen.

The key operation unit 52 can detect a press on each of the operation keys 5 by the user. The key operation unit 52 detects whether or not each of the operation keys 5 is pressed. When the operation key 5 has not been pressed, the key operation unit 52 outputs a non-operation signal indicating that the operation key 5 has not been operated to the controller 10. Upon the press on the operation key 5, the key operation unit 52 outputs an operation signal indicating that the operation key 5 has been operated to the controller 10. Accordingly, the controller 10 can determine whether or not each of the operation keys 5 is operated.

Each of the touch panel 50 and operation key 5 is one example of the input unit receiving the input to the electronic apparatus 1.

The receiver 42 outputs a reception sound and comprises, for example, a dynamic speaker. The receiver 42 can convert an electric sound signal from the controller 10 into a sound and then output the sound. The sound output from the receiver 42 is output to the outside through a receiver hole 80a located in the front surface of the electronic apparatus 1. The volume of the sound output through the receiver hole 80a is lower than the sound output from the speaker 44 through speaker holes 34a.

The receiver 42 may be replaced with a piezoelectric vibrator. The piezoelectric vibrator is controlled by the controller 10 and vibrates based on a voice signal. The piezoelectric vibrator is located on, for example, the rear surface of the cover panel 2 and causes the cover panel 2 to be vibrated by the vibration of the piezoelectric vibrator based on the voice signal. Thus, the vibration of the cover panel 2 is transmitted as a voice to an ear of the user. This case eliminates the need for the receiver hole 80a.

The speaker 44 is; for example, a dynamic speaker. The speaker 44 can convert the electric sound signal from the controller 10 into a sound and then output the sound. The sound output from the speaker 44 is output to the outside through the speaker holes 34a located in the rear surface of the electronic apparatus 1. The volume of the sound output through the speaker holes 34a can be set to a degree such that the sound can be heard at a location apart from the electronic apparatus 1. The speaker 44 outputs, for example, a ringer tone.

The voice input unit 46 is, for example, a microphone. The voice input unit 46 can convert a sound from the outside of the electronic apparatus 1 into an electric sound signal to output the signal to the controller 10. The sound from the outside of the electronic apparatus 1 is taken inside the electronic apparatus 1 through a microphone hole located in the front surface of the cover panel 2 and is received by the voice input unit 46.

The imaging unit 60 includes, for example, a first imaging unit 62 and a second imaging unit 64. The first imaging unit 62 includes an imaging lens 6a and an image sensor. The first imaging unit 62 can take a still image and a moving image based on the control by the controller 10. As illustrated in FIG. 1, the imaging lens 6a, which is located in the front surface of the electronic apparatus 1, can thus take an object located on the front surface side (cover panel 2 side) of the electronic apparatus 1.

The second imaging unit 64 includes an imaging lens 7a and an image sensor. The second imaging unit 64 can take a still image and a moving image based on the control by the controller 10. As illustrated in FIG. 2, the imaging lens 7a, which is located in the rear surface of the electronic apparatus 1, can thus take an object located on the rear surface side of the electronic apparatus 1.

The current position acquiring unit 70 can acquire its own current position. Since the current position acquiring unit 70 is housed in the electronic apparatus 1, the current position may be also referred to as a position of the electronic apparatus 1. For example, the current position acquiring unit 70, which is an apparatus using a GPS (global positioning system), receives radio waves from an artificial satellite via the wireless communication unit 20 and calculates a current position based on the radio waves by a well-known method. A current position information indicating the current position includes information about a latitude and a longitude.

The travel distance calculation unit 80 can obtain a distance which the user moves. This travel distance is generated based on information different from the position information obtained by the current position acquiring unit 70. One example of the travel distance calculation unit 80 is described in detail hereinafter.

<2. Controller>

FIG. 4 is a view schematically showing one example of the controller 10. The controller 10 includes a route processing unit 100. The route processing unit 100 is a function unit for generating a route information of a route along which the user moves (also referred to as a whole route hereinafter) and displays the whole route.

The route processing unit 100 includes a determination unit 111, a route generation unit 112, a display controller 113, and a route correction unit 114. These function units may be achieved by performing the program of the storage 103, or part or all of them may be made up of hardware. In this point, the same configuration is applied to the other function unit described hereinafter, so that the repetitive description is omitted.

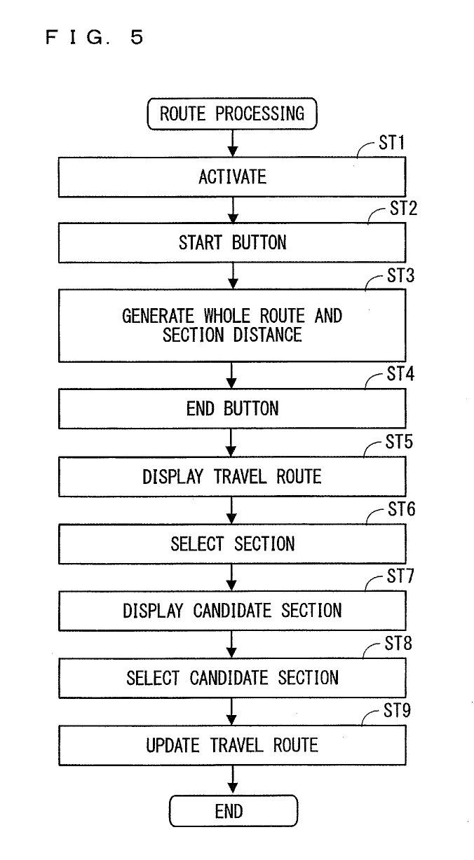

FIG. 5 is a flow chart showing one example of the operation of the controller 10. In a step ST1, the user performs an input operation to select the function of the route processing unit 100 on the electronic apparatus 1. For example, the display 30 displays a home screen (not shown), and the home screen displays a graphic (an icon, for example) to select a plurality of functions. The user performs an operation to select a graphic corresponding to the route processing unit 100 in the graphics. Applied as such an operation is, for example, an operation of bringing an operator (for example, a finger) close to or in contact with the graphic in the display area 2a and subsequently moving the operator away from the display area 2a (a so-called “tap”). In this point, the same is applied to the operation hereinafter.

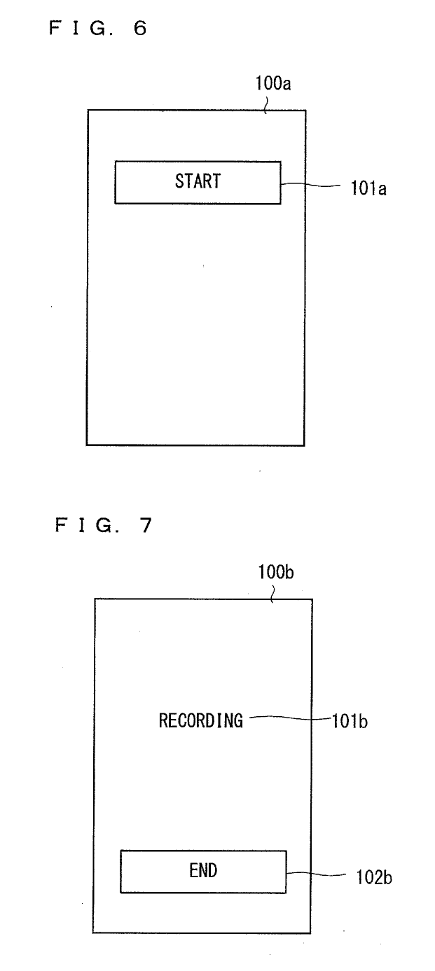

The touch panel 50 detects the operation, thereby outputting the operation ration to the route processing unit 100. The route processing unit 100 starts up in response to the input of the operation information and an initial screen 100a is displayed in the display 30. FIG. 6 is a view schematically showing one example of the screen of the display 30 and schematically illustrates one example of the initial screen 100a. In the exemplification of FIG. 6, a “start” button 101a is displayed in the initial screen 100a. The button 101a is a button for starting the generation of the route information.

The user selects the button 101a in a step ST2 and starts moving with carrying the electronic apparatus 1. The touch panel 50 detects the selection operation and the operation information is input to the route generation unit 112 and a distance calculation unit 115. A configuration of the distance calculation unit 115 is described in detail hereinafter. The route generation unit 112 can start the generation of the route information based on the current position information. The route information is information indicating the route along which the user moves.

The generation of the route information can be performed based on the current position information which is repeatedly obtained by the current position acquiring unit 70 at predetermined time intervals and a map information. The map information includes a road data made up of a link data and a node data, for example. The node data is data indicating a point of intersection, fork, and junction of each road and includes data of presence or absence of traffic light, for example. The link data is data indicating a section of the road connecting the nodes. The link data includes information of an identification number for identifying the road of each section, a road length indicating a length of the road of each section, a coordinate of starting point and ending point (for example, a latitude and a longitude) of the road of each section, a type of the road (for example, a national road), a total number of traffic lanes, a presence or absence of traffic lane exclusive for right turn or left turn, a total number of the dedicated lane, and a width of the road, for example. The map information may be stored in a storage (for example, the storage 103) in advance or may be obtained from outside using the wireless communication unit 20 or the proximity wireless communication unit 22.

The route generation unit 112 sequentially associates the current position which is repeatedly obtained by the current position acquiring unit 70 with the map information. Then, the route generation unit 112 sequentially extracts the link data including the current position from the map information and also extracts the node data connecting these link data to generate the route information. In the above case, the route information includes the link data corresponding to the current position and the node data connecting the link data.

The current position acquiring unit 70 calculates the current position based on the signal received from the plurality of satellites, so that when a reception state between the wireless communication unit 20 and the satellite is bad, for example, an accuracy of calculating the current position may be low.

The signal received from the satellite includes, for example, the following two information, that is to say, a transmission time when the satellite has transmitted the signal and a position of the satellite. In the above case, the current position acquiring unit 70 calculates a difference between the transmission time and reception time of the signal from the satellite. Since the difference depends on a straight-line distance from the satellite to the electronic apparatus 1, the straight-line distance is obtained from the difference. The electronic apparatus 1 is therefore located on a sphere with a radius equal to the straight-line distance centered at the position of the satellite.

Accordingly, when the received signal can be obtained from the three satellites, one position of the electronic apparatus 1 can be obtained. Actually, the signals received from more than three satellites are used to correct an error of a clocking circuit between the satellite and the electronic apparatus 1, for example, so that the measurement accuracy of the current position can be enhanced. Although the detailed description of such a calculation of the current position is omitted by reason that it is well-known, an acquisition accuracy of the current position is reduced when the number of satellites from which the signals can be received is small.

When the user moves in the section where the acquisition accuracy of the current position is low as described above, the route generation unit 112 may generate a route different from an actual route. In the above case, the route information includes a route different from a route along which the user has actually moved.

Therefore, it is proposed to show the user such a section route as an object of correction after generating the route information, for example. In order to achieve this, in the first embodiment, an accuracy information reflecting the acquisition accuracy of the current position is associated with each section route at the time of generating the route information.

Information of the number of satellites from which the signal could be appropriately received, for example, can be applied as such an accuracy information. The reason is that when the number of satellite is small, the acquisition accuracy of the current position is reduced as described above.

It can be determined based on a reception level (an electric power) of the received signal, for example, whether or not the received signal could be appropriately received. That is to say, when the reception level is larger than a predetermined value, it can be determined that the received signal could be appropriately received. Alternatively, it is also applicable that the received signal is analyzed and when the transmission time and the position of the satellite can be appropriately determined, it is determined that the received signal could be appropriately received.

It is determined whether or not the received signal could be appropriately received from the satellite based on the received signal for each satellite, and the number of satellites from which the received signal could be received is detected. When the number is smaller than the predetermined value, it is determined that the acquisition accuracy of the current position is low.

Alternatively, it is also applicable that in a more simple manner, without determining the number of satellites, the accuracy of obtaining the current position is estimated to be low when an average value of the reception level of the received signal from the satellite is smaller than a reference value. That is to say, the average value of the reception level of the received signal can also be applied as the accuracy info nation.

Alternatively, the current position acquiring unit 70 may obtain the current position based on not only the received signal from the satellite but also the wireless communication with a relaying apparatus or base station in a wireless communication network. The wireless communication network includes a plurality of relaying apparatuses and a plurality of base stations, and a wireless communication available range is determined for each relaying apparatus and base station. Accordingly, when the relaying apparatus or the base station with which the electronic apparatus 1 can perform the wireless communication is specified, a range where the electronic apparatus 1 is located can be specified. For example, when the electronic apparatus 1 can perform the wireless communication with the plurality of relaying apparatuses and base stations, the electronic apparatus 1 is located in a range where the communication available ranges of the plurality of relaying apparatuses and base stations overlap each other.

Furthermore, the current position acquiring unit 70 may also enhance the acquisition accuracy of the current position using both the received signal from the satellite and the range specified by the relaying apparatus when the number of satellites is small. Such a technique is also well-known, so that the detailed description is omitted.

Such a processing may enable the acquisition of the current position with sufficient accuracy. In the above case, the acquisition accuracy may be estimated to be reduced when the number of satellites is smaller than the predetermined value and the received signal cannot be received from the relaying apparatus. In the above case, the number of satellites from which the received signal can be appropriately received and the reception level of the received signal from the relaying apparatus can be applied.

The accuracy is low in the case of specifying the range using the relaying apparatus or the base station compared with the current position information. Accordingly, the acquisition accuracy may be determined to be low when the number of satellites from which the received signal could be appropriately received is smaller than the predetermined value (three, for example) even when the relaying apparatuses or the base station is used.

Herein, the average value of the reception level of the received signal from the satellite is applied as the accuracy information.

In the exemplification of FIG. 4, the determination unit 111 is provided, and the determination unit 111 can receive the received signal from the plurality of satellites via the wireless communication unit 20, detect the reception level, and calculate the average value of the reception level from the plurality of satellites. The determination unit 111 can determine whether or not the average value is higher than a predetermined reception reference value. Such a determination can be performed using an optional comparator. Subsequently, the determination result is output to the route generation unit 112.

The route generation unit 112 can, based on the determination result, distinguish between a first section route whose acquisition accuracy is estimated to be low and a second section route whose acquisition accuracy is estimated to be high, thereby generating the route information. The average value of the reception level is applied as one example herein, so that the first section route is a section route formed by the current position calculated using the received signal in which the average value is smaller than the reception reference value.

As one example of the specific operation, when the average value of the reception level transits from a state larger than the reception reference value to a state smaller than the reception reference value, the route generation unit 112 stores the current position at that time as a starting point of the first section route. Then, when the average value of the reception level transits from a state smaller than the reception reference value to a state larger than the reception reference value, the route generation unit 112 stores the current position at that time as an ending point of the first section route. The whole route can be thereby detected while distinguishing between the first section route and the second section route.

The generated route information includes not only a plurality of link data extracted based on the current position and a link data connecting the plurality of link data but also information of the first section route, for example. There may be a plurality of first section routes, so that the information of the first section route includes an identification information for identifying the first section route and information of the starting point and ending point of each first section route.

The route generation unit 112 may display a display screen 100b different from the initial screen 100a during the generation of the route information. FIG. 7 is a view schematically showing one example of the screen of the display 30 and schematically illustrates one example of the display screen 100b. In the exemplification of FIG. 7, a sentence 101b indicating that the route information is being generated and an “end” button 102b are displayed in the display screen 100b. The “end” button 102b is a button for inputting the ending point of the whole route.

When the user reaches the ending point of the whole route, for example, the user selects the button 102b in a step ST4. When the button 102b is selected, the operation information is detected by the touch panel 50 and is then input to the route generation unit 112. The route generation unit 112 determines the current position at the time of inputting the operation information as the ending point of the whole route and then finishes the generation of the route information. The route generation unit 112 stores the generated route information in a storage (the storage 103, for example). The route information includes, for example, the information of the starting point and ending point of the whole route, the plurality of link data between them, the node data connecting these link data, and the information of the first section route.

A distance calculation unit 115 also operates in a step ST3. The distance calculation unit 115 can generate information of a distance which the user has moved during a period when the average value of the reception level is lower than the reference value (also referred to as a section distance hereinafter) using information different from the current position information.

The distance calculation unit 115 uses a pedometer 81, for example. The pedometer 81 includes an acceleration sensor, for example, so that it can measure a total number of steps of the user based on an acceleration rate detected by the acceleration sensor. The distance calculation unit 115 measure the number of steps from a start of movement (that is to say, the selection of the button 101a), for example, using the pedometer 81. The number of steps is measured in association with the current position. That is to say, the current position obtained at a certain point of time and the number of steps measured at the certain point of time are associated with each other.

For example, the current position acquiring unit 70 calculates the current position and obtains the current time, associates the position and time with each other, and stores the data in a storage (the storage 103, for example). The current time is determined by an optional timer circuit, for example. Similarly, the distance calculation unit 115 measures the number of steps using the pedometer 81 and obtains the current time at that time, associates the number of steps and time with each other, and stores the data in a storage (the storage 103, for example). The number of steps and the current position at the same time are thereby associated with each other. The number of steps and the current position may be directly associated with each other.

The distance calculation unit 115 calculates a difference between the number of steps corresponding to the ending point of the first section route and the number of steps corresponding to the starting point of the first section route. This difference corresponds to the number of steps of the user in a period of time in which the average value of the reception level is smaller than the reception reference value. The distance calculation unit 115 multiplies the difference by a distance per step, which is preset, to calculate the section distance. The information of the section distance is output to the route correction unit 114.

As described above, according to the route processing unit 100, the first section route whose acquisition accuracy of the current position is estimated to be low is detected, and a section travel distance which the user has moved from the starting point to the ending point of the first section route is calculated. This section travel distance does not necessarily coincide with the distance of the first section route. The reason is that when the current position acquiring unit 70 obtains the current position with low accuracy, the first section route may be different from the route along which the user has actually moved. That is to say, it can be estimated that this section distance indicates the distance which the user has actually moved between the starting point of the first section route and the ending point of the first section route rather than the distance of the first section route generated based on the current position information.

In the route processing unit 100, as described in detail hereinafter, the first section route is indicated to the user as the section route to be corrected. The section travel distance is used for selecting a candidate replaced with the first section route as described hereinafter.

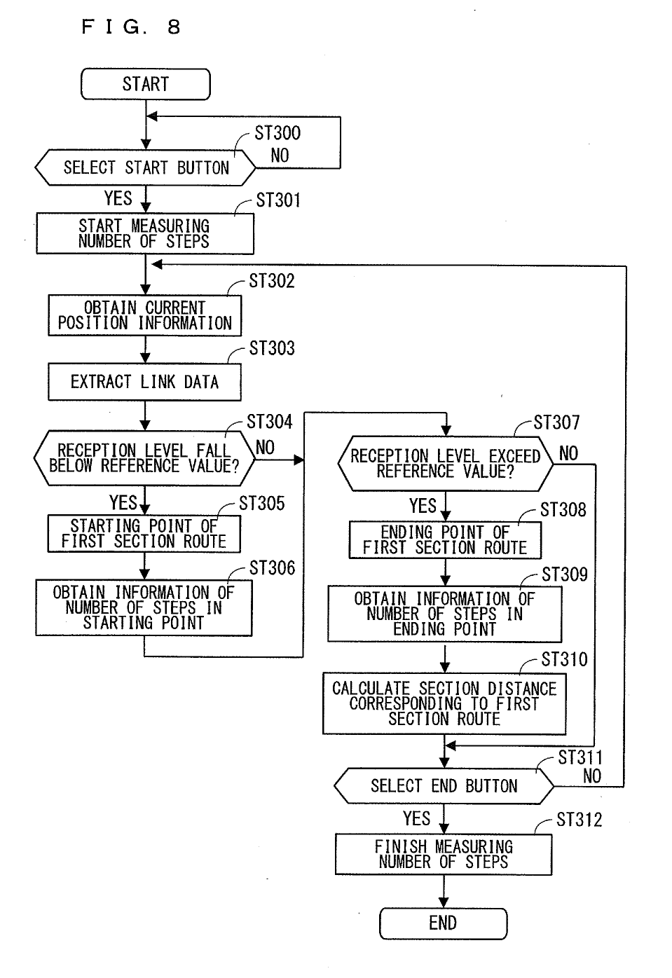

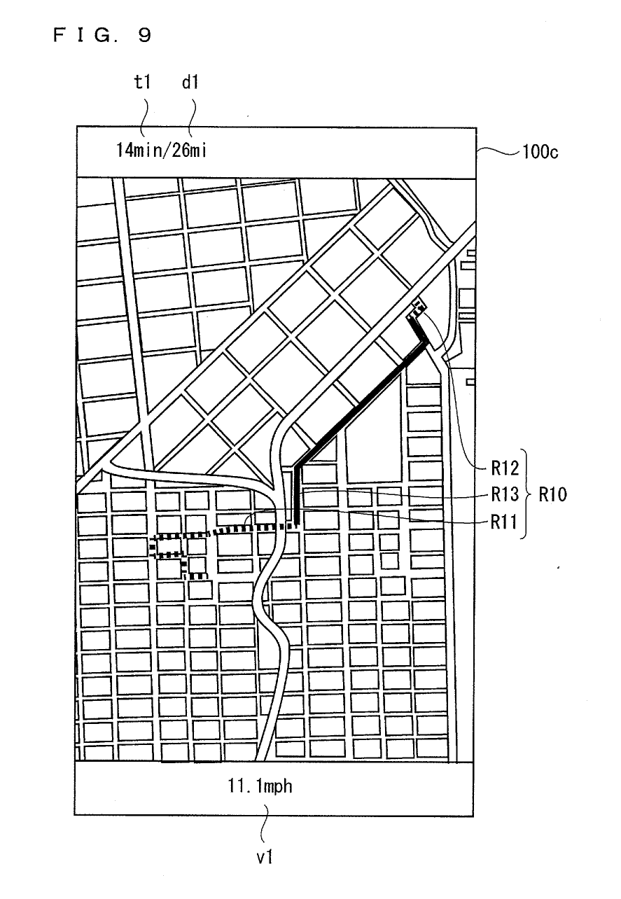

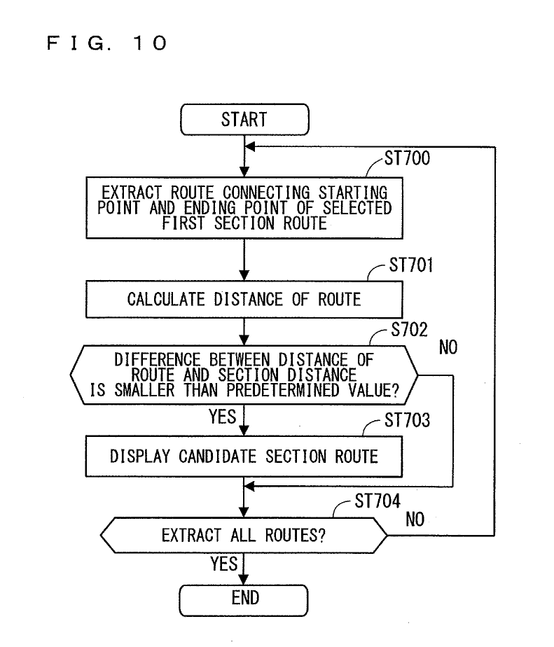

FIG. 8 is a flow chart showing one example of the operation of the controller 10 and illustrates one example of a flow corresponding to the steps ST2 to ST4. In a step ST300, the route processing unit 100 determines whether or not the “start” button 101a is selected and performs the step ST300 again when a negative determination is made. When a positive determination is made in the step ST300, the pedometer 81 starts measuring the number of steps in a step ST301. Next, in a step ST302, the route generation unit 112 obtains the current position information from the current position acquiring unit 70. Next, in a step ST303, the route generation unit 112 extracts the link data including the current position from the map information and also extracts the node data connecting the extracted link data. When the link data is already extracted, the extraction does not need to be performed again.

Next, in a step ST304, the determination unit 111 determines whether or not the average value of the reception level falls below the reception reference value. That is to say, the determination unit 111 determines whether or not the average value of the reception level transits from a state larger than the received signal to a state smaller than the received signal. When a positive determination is made, the route generation unit 112 determines the current position as the starting point of the first section route in a step ST305. Next, in a step ST306, the distance calculation unit 115 obtains information of the number of steps from the pedometer 81 and determines it as the information of the number of steps corresponding to the starting point.

When a negative determination is made in the step ST304, or after executing the step ST306, the determination unit 111 determines whether or not the average value of the reception level exceeds the reception reference value in a step ST307. That is to say, the determination unit 111 determines whether or not the average value of the reception level transits from a state smaller than the received signal to a state larger than the received signal. When a positive determination is made, the route generation unit 112 determines the current position as the ending point of the first section route in a step ST308. Next, in a step ST309, the distance calculation unit 115 obtains information of the number of steps from the pedometer 81 and determines it as the information of the number of steps corresponding to the ending point. Next, in a step ST310, the distance calculation unit 115 calculates the section distance corresponding to the first section route based on the information of the number of steps. For example, the distance calculation unit 115 subtracts the number of steps at the starting point of the first section route from the number of steps at the ending point of the first section route and multiplies the subtraction result by the distance per step to generate the section distance.

When a negative determination is made in the step ST307, or after executing the step ST310, the route processing unit 100 determines whether or not the “end” button 102b is selected in a step ST311. When a negative determination is made, the step ST302 is performed again. When a positive determination is made in the step ST311, the pedometer 81 finishes measuring the number of steps in a step ST312. The link data and node data extracted as described above and the information of the starting point and ending point of the first section route are examples of the route information.

Next, in a step ST5, the display controller 113 can display the whole route on the display 30 based on the route information received from the route generation unit 112. In the exemplification of FIG. 5, the step ST5, triggered by the finish of the step ST4, is performed, however, the configuration is not necessarily limited thereto. For example, it is also applicable that a “display” button for displaying the whole route is provided in the initial screen 100a and the display controller 113 displays the initial screen 100a when the step ST4 is finished. Then, the step ST5 may be performed in response to the selection of the “display” button.

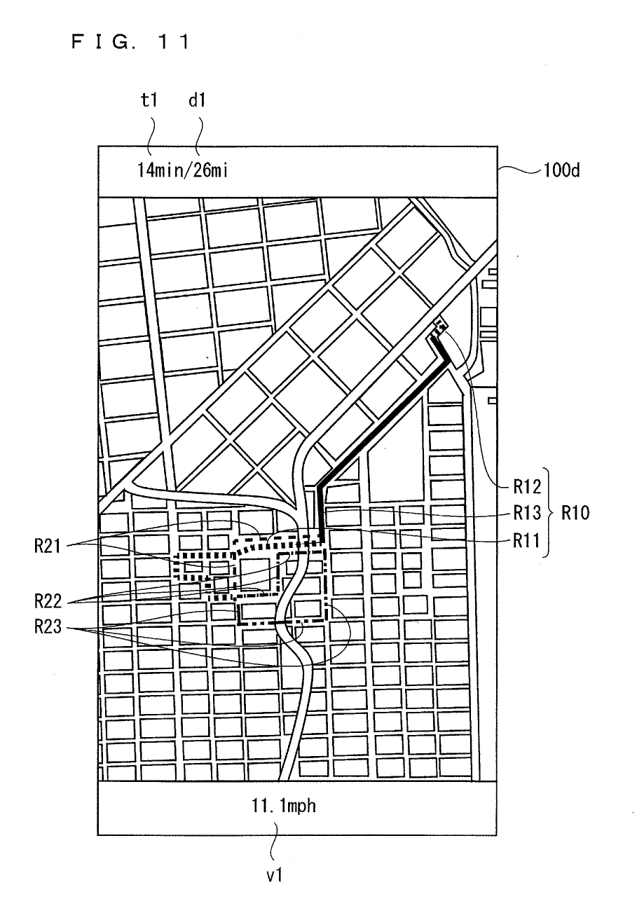

FIG. 9 is a view schematically showing one example of the screen of the display 30 and illustrates one example of a display screen 100c in which the whole route is displayed. According to the exemplification of FIG. 9, the display controller 113 displays a map around a whole route R10 based on the map information. Displayed on the map is the whole route R10 in which the first section route and the second section route are displayed in a different display form. In the exemplification of FIG. 9, section routes R11 and R12 correspond to the first section route, and a section route R13 corresponds to the second section route.

The display controller 113 displays the first section route and the second section route in colors different from each other, for example. Alternatively, it is also applicable to distinguish between the first section route and the second section route and displays them by varying a thickness of line or type of line indicating the section route.

The user can thereby visually recognize the first section route easily. When the first section route is different from the route along which the user has actually moved, the user performs an input operation to correct the first section route in a step ST6. For example, the user selects the section route R11 as the route to be corrected. When the touch panel 50 detects the selection operation, the operation information is input to the route correction unit 114.

In a step ST7, the route correction unit 114 to which the operation information is input determines an ending point and a starting point of the section route R11 based on the route information and extracts a plurality of routes connecting them from the map information.

At that time, the route correction unit 114 can select the candidate replaced with the selected first section route (referred to as the candidate section route hereinafter) using the section distance calculated by the distance calculation unit 115. More specifically, the route correction unit 114 can select, as the candidate section route, a route having a distance, in which a difference between the distance and the section distance corresponding to the section route R11 calculated by the distance calculation unit 115 is smaller than a predetermined value, in the plurality of routes. For example, the route correction unit 114 calculates the distance of each route by appropriately integrating a road length of the link data forming the plurality of routes. Subsequently, the route correction unit 114 calculates a difference between the distance of each route and the section distance corresponding to the section route R11 generated by the distance calculation unit 115, and determines whether or not the difference is larger than a distance difference reference value. When a positive determination is made, the route correction unit 114 extracts the route as the candidate section route. The display controller 113 displays the candidate section route on the map of the display 30. When a negative determination is made, the route correction unit 114 does not set the route as the candidate section route. The distance difference reference value may be preset, for example, and stored in a storage (for example, the storage 103) or the like.

FIG. 10 is a flow chart showing one example of the operation of the route correction unit 114 and illustrates one example of a flow corresponding to the step ST7. In a step ST700, the route correction unit 114 extracts one route connecting the ending point and the starting point of the selected section route R11 from the map information. Next, in a step ST701, the route correction unit 114 calculates the distance of the route based on the map information. For example, the route correction unit 114 appropriately integrates the road length of the link data forming the route. Next, in a step ST702, the route correction unit 114 determines whether or not a difference of the calculated distance of the route and the section distance corresponding to the section route R11 is smaller than the distance difference reference value. When a positive determination is made, the route correction unit 114 extracts the route as the candidate section route. The display controller 113 displays the candidate section route on the map of the display 30. When a negative determination is made in the step ST702, or after executing a step ST703, the route correction unit 114 determines whether or not all the routes are extracted in a step ST704. When a negative determination is made, the route correction unit 114 performs the step ST700 again. In the step ST700, one route other than the route which has been extracted before is extracted. When a positive determination is made in the step ST704, the route correction unit 114 finishes the operation.

FIG. 11 is a view schematically illustrating one example of the screen of the display 30, and schematically illustrates one example of a display screen 100d in which a plurality of candidate section routes R21 to R23 are displayed. For example, the candidate section routes R21 to R23 may be displayed in display forms different from each other (for example, colors, widths of line, or types of line different from each other).

As described above, according to the route correction unit 114, the electronic apparatus 1 can display the route having a distance, in which a difference between the distance and the section distance generated by the distance calculation unit 115 is smaller than the distance difference reference value, as the candidate section route. The electronic apparatus 1 can therefore display the route along which the user is likely to have moved. The electronic apparatus 1 may display, as the candidate section route, only a route having a distance, in which a difference between the distance and the section route is smaller than the distance difference reference value, in the plurality of routes connecting the starting point and the ending point of the selected first section route.

Next, in a step ST8, the user selects the route along which the user has moved from among the candidate section routes R21 to R23. For example, the user selects the candidate section route R21. The touch panel 50 detects this selection operation, and the operation information is input to the route correction unit 114. The route correction unit 114 replaces the selected candidate section route R21 with the first section route R11 to update the route information.

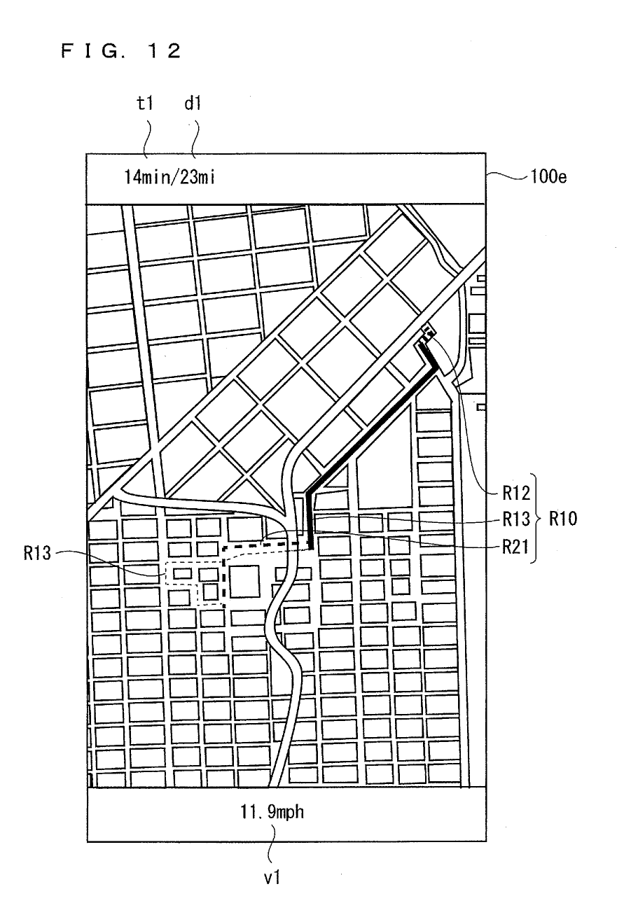

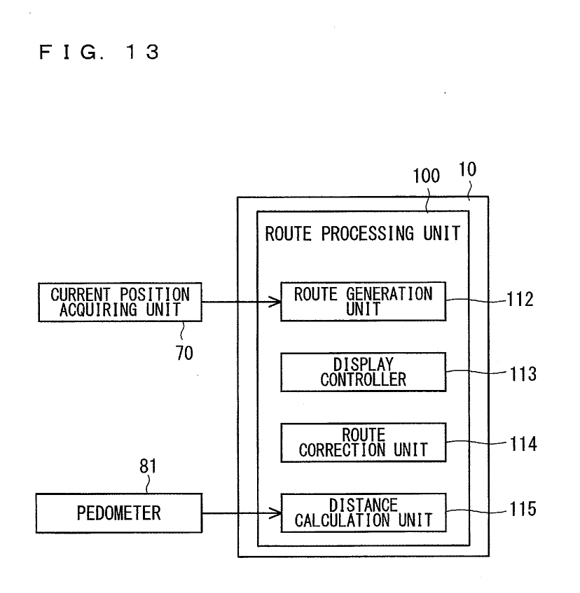

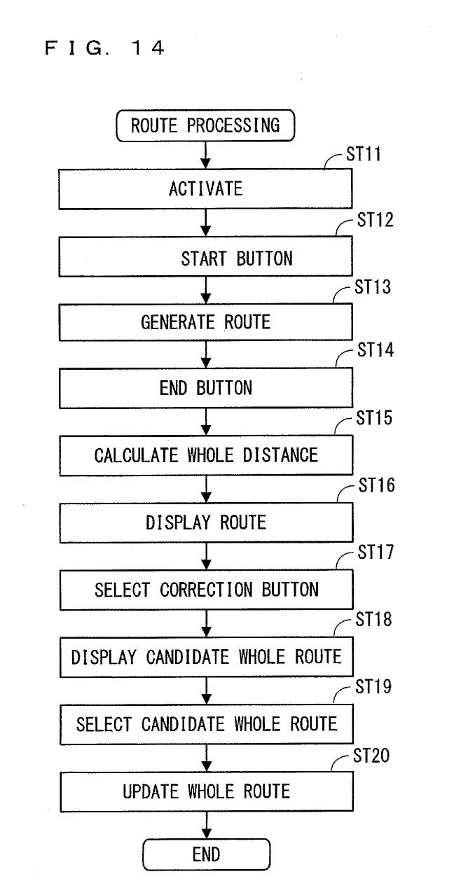

The display controller 113 can display the whole route R10 after being updated. FIG. 12 is a view schematically showing one example of the screen of the display 30 and schematically illustrates one example of a display screen 100e which displays the whole route R10 after being updated. In the exemplification of FIG. 12, the selected section route R21 and the section routes R12 and R13 form the whole route R10.

In the exemplification of FIG. 12, the section route R21 is displayed while being distinguished from the section routes R12 and R13. The user can thereby visually recognize that the section route R21 is the corrected section route easily. In the exemplification of FIG. 12, the section route R21 is displayed while being distinguished from the other section routes. Accordingly, the user can visually recognize easily that there is an uncorrected first section route (the section route R12 herein) even after correcting the section route R11.

In the exemplification of FIG. 12, the section route R11 is displayed in a display form different from that of the whole route R10. The user can thereby visually recognize the section route R11, which is mistakenly generated, easily. Accordingly, the user can recognize the section route whose acquisition accuracy of the current position is low even after correcting the route.

The electronic apparatus 1 may display the section routes R21 and R12 in the same display form. Accordingly, the electronic apparatus 1 can display the route without distinguishing the correct route. The electronic apparatus 1 may display the section routes R12 and R13 in the same display form or may display the section routes R21, R12, and R13 in the same display form.

The electronic apparatus 1 may be provided with a predetermined button in the display screen to switch these display faints in response to the selection of the button.

Moreover, the electronic apparatus 1 may finish displaying the first section route R11 when the input operation for selecting the candidate section route is received via the input unit (for example, the touch panel 50). Accordingly, the electronic apparatus 1 hardly displays the erroneous route.

As described above, according to the route processing unit 100, the electronic apparatus 1 displays, at the time of displaying the whole route R10, the first section route whose acquisition accuracy of the current position is estimated to be low to be distinguished from the second section route whose acquisition accuracy of the current position is estimated to be high. The user can thereby visually recognize the first section route which is relatively likely to be incorrect easily.

In addition, when the user selects this first section route, the electronic apparatus 1 may display candidate section routes alternative to the section route. The electronic apparatus 1 may correct the whole route when the user selects one of the candidate section routes. In the above manner, the electronic apparatus 1 may correct the first section route as a unit. Accordingly, the user can designate the section route to be corrected with a simple input operation.

Furthermore, the distance calculation unit 115 calculates the section distance based on information different from the current position obtained by the current position acquiring unit 70. The route correction unit 114 displays the section route having a distance, in which a difference between the distance and the section distance calculated by the distance calculation unit 115 is smaller than the distance difference reference value, as the candidate section route. The electronic apparatus 1 therefore displays the section route along which the user is likely to have moved as the candidate section route. Accordingly, usability of the electronic apparatus 1 can be enhanced.

The electronic apparatus 1 may select the section route which satisfies not only a condition of distance but also the following condition, for example, as the plurality of candidate section routes. The electronic apparatus 1 may select a section route in which a road width is larger than a predetermined value, a section route in which a total number of traffic lights is smaller than a predetermined value, or a section route in which a total number of curved paths is smaller than a predetermined value, for example. The electronic apparatus 1 may detect the road width, number of traffic lights, and number of curved paths in each section route based on the map information, for example.

The display controller 113 may initially display the whole route without distinguishing between the first section route and the second section route. At that time, the display controller 113 may display a button for distinguishing between the first section route and the second section route. The display controller 113 may distinguish between the first section route and the second section route and displays them when the display controller 113 receives the information of the operation of selecting the button from the touch panel 50.

In the above example, the function of the travel distance calculation unit 80 in FIG. 3 is achieved by the pedometer 81 and the distance calculation unit 115 in FIG. 4. That is to say, the electronic apparatus 1 calculates the section distance based on the number of steps of the user. Moreover, the configuration is not necessarily limited thereto. For example, the electronic apparatus 1 may integrate the acceleration rate detected by the acceleration sensor twice to calculate the distance.

The electronic apparatus 1 does not need to include all of the functions of the travel distance calculation unit 80. For example, a wearable equipment attached to the user may include the acceleration sensor. The wearable equipment includes a mounting fixture (for example, a belt or a clip) and is attached to the user via the mounting fixture. The wearable equipment may include a wireless communication unit (for example, a proximity wireless communication unit), so that the wearable equipment and the electronic apparatus 1 can perform a wireless communication with each other. In such a system, the information of the acceleration rate detected by the acceleration sensor may be transmitted to the electronic apparatus 1 via the proximity wireless communication unit.

The information of the acceleration rate is input to the distance calculation unit 115 via the proximity wireless communication unit 22 in the electronic apparatus 1. The distance calculation unit 115 measures the number of steps, for example, based on the information of the acceleration rate and multiplies a preset distance per step by the number of steps, thereby calculating the distance. Alternatively, the distance calculation unit 115 may integrate the acceleration rate twice to calculate the distance, for example.

The wearable equipment may perform at least part of the calculation in the distance calculation unit 115 and transmit the calculation result from the wearable equipment to the electronic apparatus 1. For example, the wearable equipment may calculate the number of steps, the acceleration, or the distance and transmits the information from the wearable equipment to the electronic apparatus 1.

Considered next is a case of providing the acceleration sensor to both the electronic apparatus 1 and the wearable equipment. Assumed herein is a case where the electronic apparatus 1 is a portable equipment and is not provided with a mounting fixture. The electronic apparatus 1 is housed in a bag, for example, in some cases. In the meanwhile, the wearable equipment is likely to be attached to the user. Accordingly, the information of the acceleration rate of the wearable equipment is more likely to reflect a motion of the user.

Therefore, when the electronic apparatus 1 is the portable electronic apparatus and the acceleration sensor is provided to both the wearable equipment and the electronic apparatus 1, the distance calculation unit 115 may preferentially use the information of the wearable equipment to obtain the distance. For example, the distance calculation unit 115 may require the information (the information of the acceleration rate, number of steps, speed, or distance) from the wearable equipment via the proximity wireless communication unit 22, and when the distance calculation unit 115 can obtain the information, it may obtain the distance using the information from the wearable equipment. In contrast, when the distance calculation unit 115 cannot obtain the information, it may calculate the distance using the information of the acceleration sensor in the electronic apparatus 1, for example.

The route processing unit 100 may detect a travel time, a travel distance, and an average travel speed at the time of the movement of the user. For example, the travel time can be obtained by starting timing using a known timer circuit when the “start” button 101a is selected and finishing timing when the “end” button 102b is selected. The travel distance can be obtained by appropriately integrating the road length of the link data included in the route information, for example. It is indisputable that in the case of link data including the starting point or the ending point, the road length is not simply added but the road length is added in consideration of the position of the starting or the position of the ending point. For example, in the case of the link data including the position of the starting point, the road length between the end part connecting to a next link data and the starting point may be added. The same applies to ending point. The average travel speed is calculated by dividing the travel distance by the travel time, for example. A travel time t1, a travel distance dl and an average travel speed v1 are shown in FIGS. 9, 11, and 12. According to the exemplification of FIG. 12, the route processing unit 100 updates the travel distance dl and the average travel speed v1 when the route information is updated and displays them on the display unit 30.

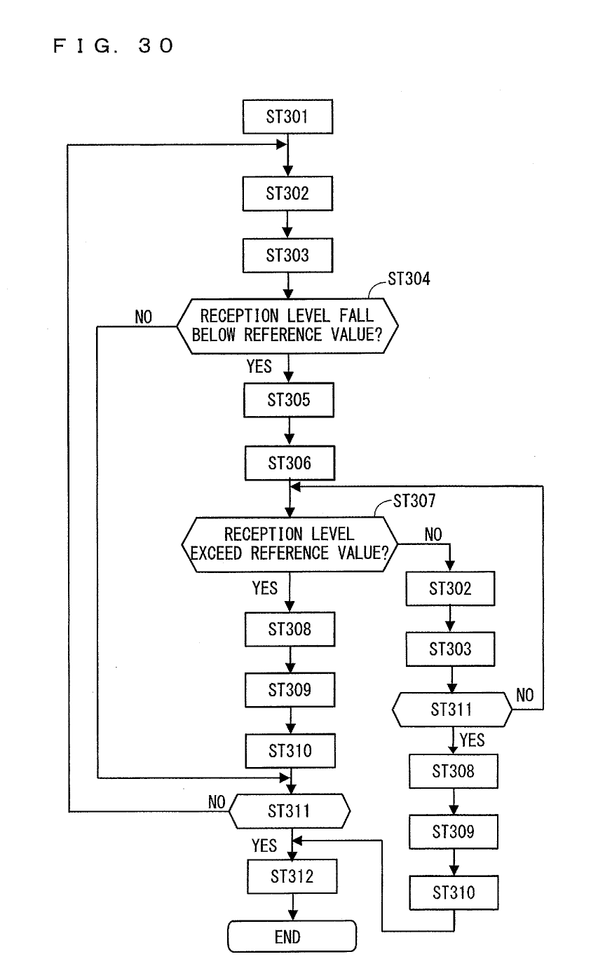

In the step ST304 in FIG. 8, the determination unit 111 determines whether or not the average value of the reception level transits from the state larger than the reception reference value to the state smaller than the reception reference value, however, the configuration is not limited thereto. For example, the determination unit 111 may determine whether or not the average value of the reception level is smaller than the reception reference value in the step ST304. In the step ST307 in FIG. 8, the determination unit 111 determines whether or not the average value of the reception level exceeds the reception reference value, however, the configuration is not limited thereto. For example, the determination unit 111 may determine whether or not the average value of the reception level is larger than the reception reference value in the step ST307. In the above case, the processing of FIG. 8 is corrected as shown in FIG. 30. In FIG. 30, signs of the steps in FIG. 8 are shown inside the blocks, and they mean that each block is the same as the step in FIG. 8.

The step ST301 is executed after the step ST300 (the flow chart starts with the “ST301” in FIG. 30), the step ST302 is executed after the step ST301, the step ST303 is executed after the step ST302, and the step ST304 is executed after the step ST303. When the average value of the reception level is smaller than the reception reference value at the time of executing the step ST304, the step ST305 is executed, the step ST306 is executed after the step ST305 is executed, and the step ST307 is executed after the step ST306. When the average value of the reception level is not larger than the reception reference value in the step ST307, the processing of the step ST302 is executed, the processing of the step ST303 is executed after the processing of the step ST302 is executed, and the processing of the step ST311 is executed after the processing of the step ST303. When the negative determination is made in the step ST311, the processing of the step ST307 is executed again, and when the positive determination is made in the step ST311, the processing of the steps ST308, ST309, ST310, and ST312 is sequentially executed, and the processing is finished.

When the average value of the reception level is not smaller than the reception reference value in the above step ST304, the processing of the step ST311 is executed. When the negative determination is made in the processing of the step ST311, the step ST302 and the step ST303 are executed and the procedure returns to the processing of the step ST304 again, and when the positive determination is made in the processing of the step ST311, the step ST312 is executed, and the processing is finished.

When the average value of the reception level is larger than the reception reference value in the processing of the above step ST307, the processing of the steps ST308, ST309, and ST310 is executed, and subsequently, the procedure transits to the step ST311. When the negative determination is made in the step ST311, the processing of the step ST302 and ST303 is executed, and the processing of the step ST304 described above is executed. When the positive determination is made in the step ST311, the processing of the step ST312 is executed and the processing is finished.

In the one example, the steps ST304 and ST307 are determined based on the average value of the reception level and the reception reference value, however, the configuration is not limited to thereto. As described in paragraph 0050, for example, the determination may be made based on the number of satellites which could receive the received signal. For example, the determination unit 111 may determine in the step ST304 whether or not the number of satellites which could receive the received signal is smaller than the predetermined number, and the determination unit 111 may determine whether or not the number of satellites which could receive the received signal is equal to or larger than the predetermined number in the step ST307. That is to say, the average value of the reception level, for example, can be replaced with the number of satellites which could receive the received signal. Such the replacement can be applied to all of the embodiments of the present disclosure.

### Second Embodiment

The electronic apparatus 1 according to the second embodiment has a configuration similar to that of the first embodiment. However, in the second embodiment, the first section route and the second section route are not necessarily distinguished. A case of displaying the whole route without distinguishing between the first section route and the second section route is described hereinafter.

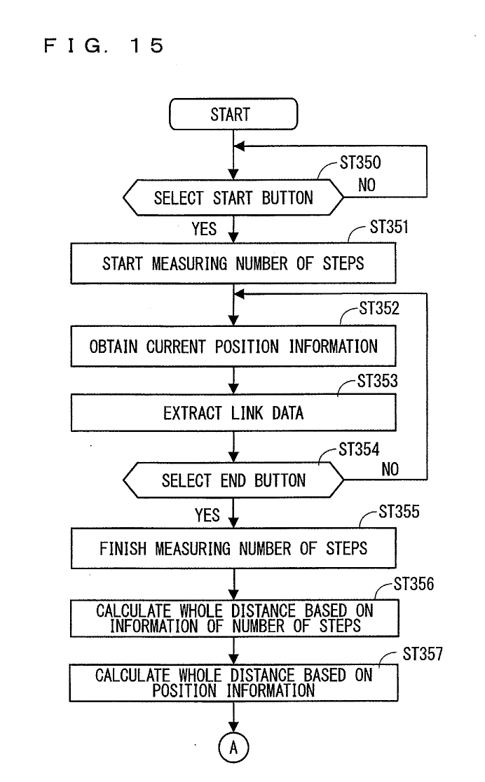

FIG. 13 is a view schematically illustrating one example of the controller 10, wherein the determination unit 111 is not provided in the route processing unit 100 when compared with the configuration shown in FIG. 4. The route generation unit 112 therefore generates the route information based on the current position information without distinguishing between the first section and the second section at the time of the movement of the user.

FIG. 14 is a flow chart illustrating one example of the operation of the controller 10. Steps ST11 and ST12 are the same as the steps ST1 and ST2, respectively. In a step ST13, the route generation unit 112 generates the route information based on the current position information. However, the route information is generated without the information of the first section route and the second section route herein. Next, in a step ST14, the user selects the “end” button 102b.

Next, in a step ST15, the distance calculation unit 115 obtains each of the travel distance from the starting point to the ending point of the whole route (referred to as the whole distance hereinafter), for example, based on the following two information.

Firstly, the distance calculation unit 115 obtains a whole distance D1 based on information different from the current position information. For example, the distance calculation unit 115 uses the information of the number of steps in the pedometer 81 in a manner similar to the first embodiment. As a more specific example, the distance calculation unit 115 starts counting the number of steps using the pedometer 81 along with the start of the movement of the user (for example, the selection of the “start” button 101a). The distance calculation unit 115 finishes counting the number of steps using the pedometer 81 along with the finish of the movement (for example, the selection of the “end” button 102b). The distance calculation unit 115 thereby measures the number of steps necessary for the movement in the whole route. Subsequently, the distance calculation unit 115 multiplies the distance per step by the number of steps, thereby calculating the whole distance D1.

Secondly, the distance calculation unit 115 calculates a whole distance D2 based on the current position information. More specifically, the distance calculation unit 115 calculates the whole distance D2 using the route information generated based on the current position information. The above calculation can be performed by appropriately integrating the road length of the link data included in the route information, for example.

As described above, in the second embodiment, the distance calculation unit 115 calculates the whole distance D2 based on the current position information and also calculates the whole distance D1 based on the information different from the current position information.

FIG. 15 is a flow chart illustrating one example of the operation of the controller 10, and illustrates one example of the operation of the route processing unit 100 corresponding to the steps ST12 to ST15 more specifically. Steps ST350 to ST353 are the same as the steps ST300 to ST303, respectively. It is determined whether or not the button 102b is selected in a step ST354 following the step ST353. When a negative determination is made, the step ST352 is executed again. When a positive determination is made, the pedometer 81 finishes measuring the number of steps in a step ST355. Next, in a step ST356, the distance calculation unit 115 calculates the whole distance D1 based on the information of the number of steps and calculates the whole distance D2 based on the current position information in a step ST357.

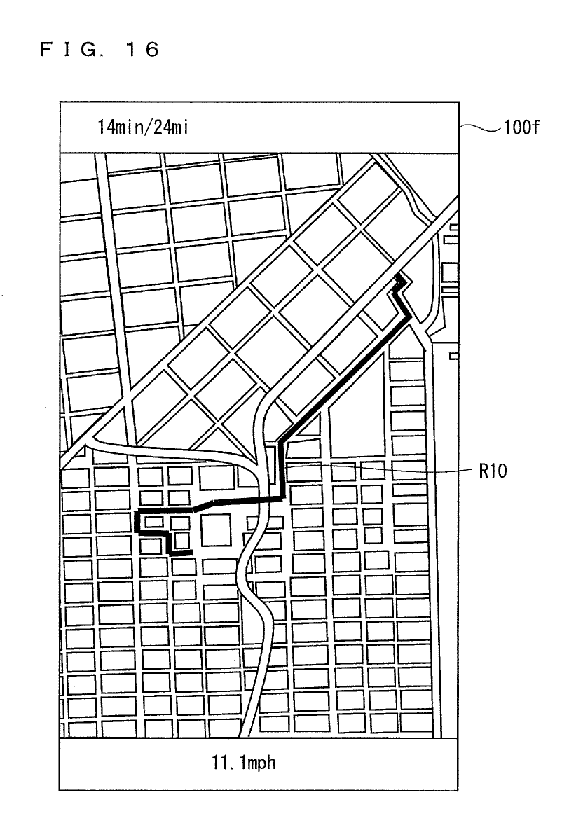

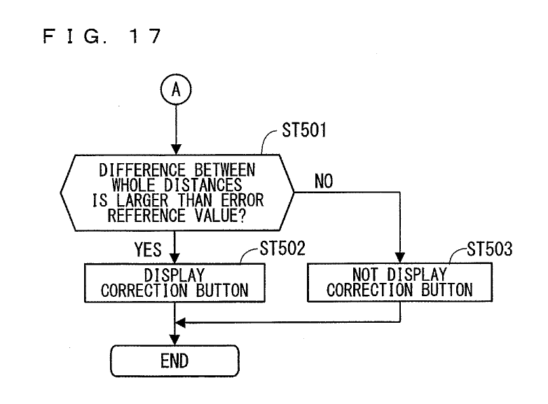

Next, in a step ST16, the display controller 113 displays the whole route R10 based on the route information. FIG. 16 is a view schematically illustrating one example of the screen of the display 30, and schematically illustrates one example of the display screen 100f at the time of displaying the whole route R10. In the exemplification of FIG. 16, the whole route R10 is displayed without distinguishing between the first section route and the second section route.

When the whole distance D2 calculated based on the current position information is substantially different from the whole distance D1 calculated based on the information different from the current position information, the route information may be incorrect.

The display controller 113 therefore calculates a difference between the whole distances D1 and D2 and determines whether or not the difference is larger than an error reference value. When a positive determination is made, the display controller 113 displays values of the whole distances D1 and D2 and display a “correct” button described hereinafter. When a negative determination is made, they are not displayed. The error reference value is stored in a storage (for example, the storage 103) and is a value used to determine whether or not the “correct” button needs to be displayed.

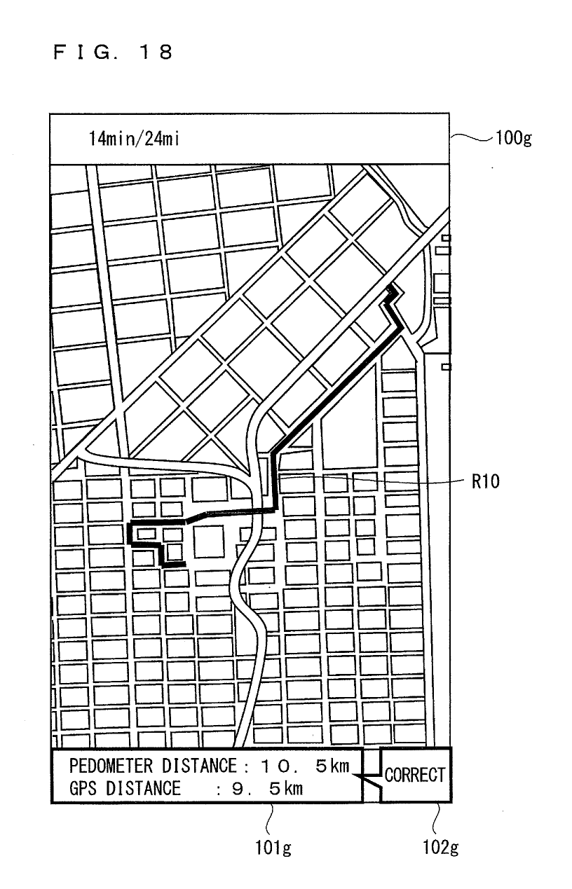

FIG. 17 is a flow chart illustrating one example of the operation of the display controller 113. In the step ST501, the determination unit 111 determines whether or not the difference between the whole distances D1 and D2 is larger than the error reference value. When a positive determination is made, the display controller 113 displays the “correct” button in a step ST502, and when a negative determination is made, the display controller 113 does not display the “correct” button in a step ST503.

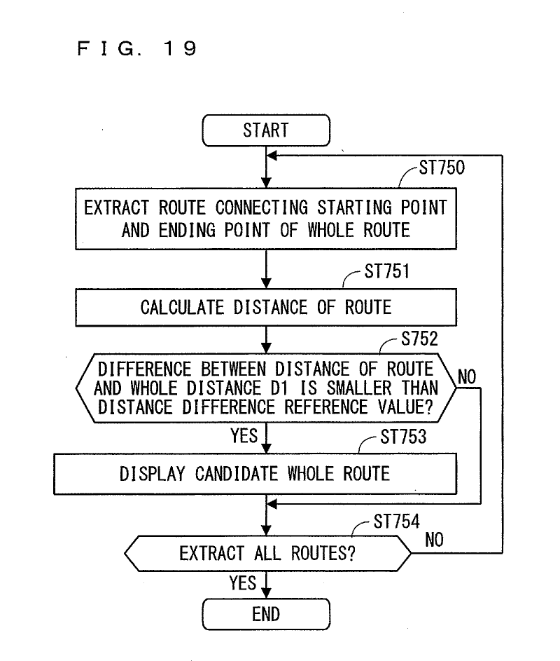

FIG. 18 is a view schematically illustrating one example of the screen of the display 30, and schematically illustrates one example of a display screen 100g in which the “correct” button 102g is displayed. The display screen 100g includes a travel distance region 101g, and “a pedometer distance” as the whole distance D1 and “a GPS distance” as the whole distance D2 are displayed in the travel distance region 101g.

Accordingly, the user can visually recognize that the whole distances D1 and D2 are substantially different from each other. The confirmation whether or not the whole route R10 is correct can be thereby promoted. When the user determines that the whole route R10 is not correct, the user selects the “correct” button 102g in a step ST17. The touch panel 50 detects the selection operation, and the operation information is input to the route correction unit 114. Upon reception of the operation information, the route correction unit 114 extracts a plurality of routes connecting the starting point and the ending point of the whole route R10 in a step ST18 and displays it as a candidate replaced with the whole route (referred to as the candidate whole route hereinafter) on the display 30.

At this time, displayed on the display 30 is a route having a distance in which a difference between the distance and the whole distance D1 is smaller than the distance difference reference value as the candidate whole route. Accordingly, the route along which the user is likely to have moved actually is applied as the candidate whole route.

FIG. 19 is a flow chart illustrating one example of the operation of the route correction unit 114 described above. In a step ST750, the route correction unit 114 extracts one of the routes connecting the starting point and the ending point of the whole route from the map information. Next, in a step ST751, the route correction unit 114 calculates a distance of the route based on the map information. For example, the road length of the link data constituting the route is appropriately integrated. Next, in a step ST752, the route correction unit 114 determines whether or not a difference between the distance of the route and the whole distance D1 is smaller than the distance difference reference value. When a positive determination is made, the route is extracted as the candidate whole route. The display controller 113 displays the candidate whole route on the display 30. When a negative determination is made in the step ST752, or after executing a step ST753, the route correction unit 114 determines whether or not all of the routes are extracted in a step ST754. When a negative determination is made, the step ST750 is executed again. In the step ST750, the route other than the route which has been extracted before is extracted. When a positive determination is made in the step ST754, the operation is finished.

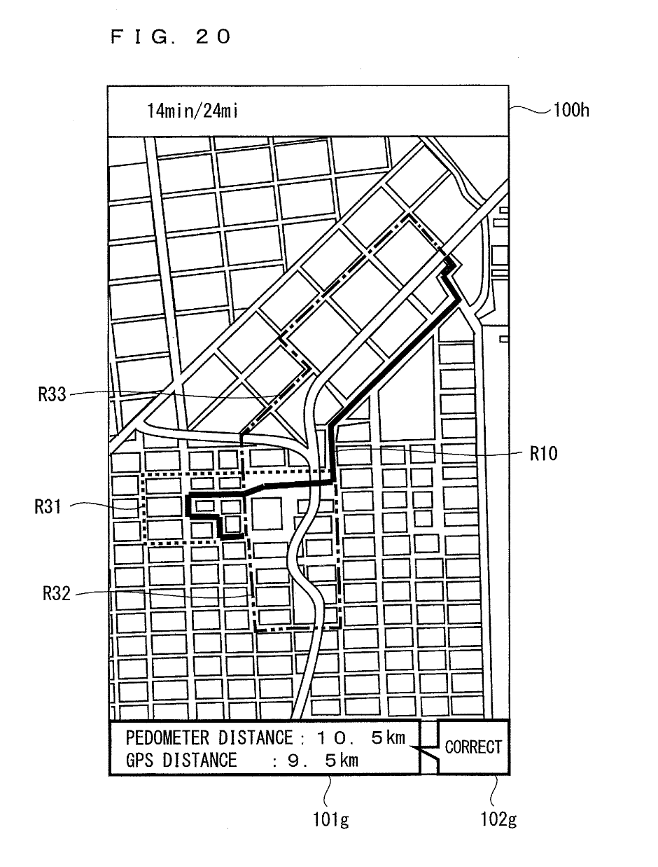

FIG. 20 is a view schematically illustrating one example of the screen of the display 30, and schematically illustrates one example of a display screen 100h in which candidate whole routes R31 to R33 are displayed. In the exemplification of FIG. 20, each part of the candidate whole routes R31 to R33 overlapping the whole route R10 is illustrated in the display form of the whole route R10.

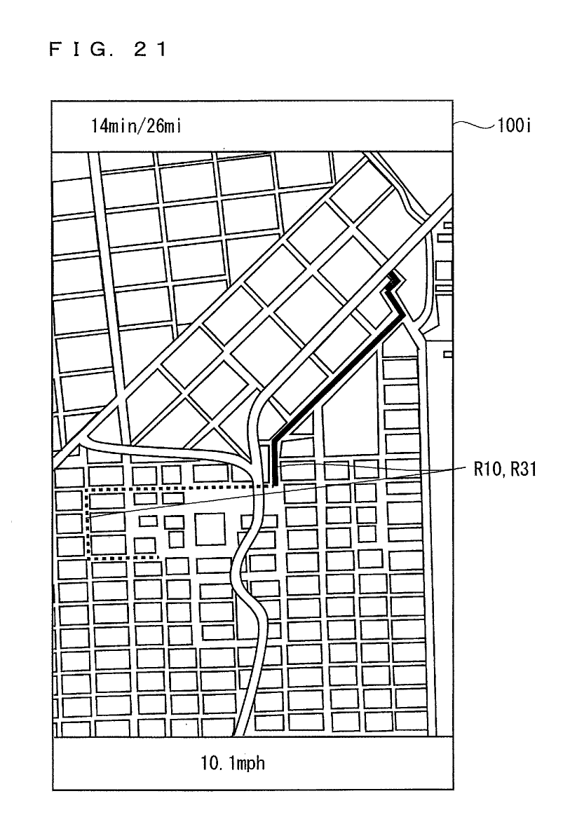

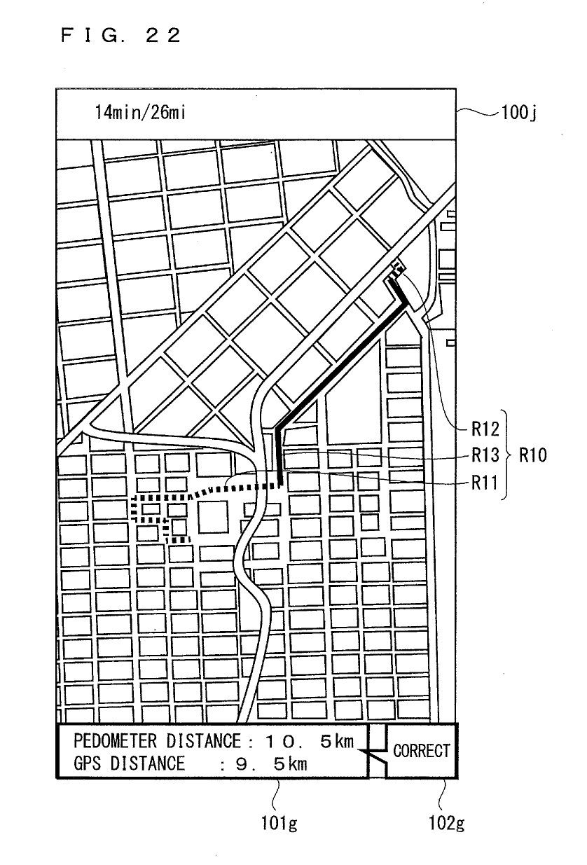

Subsequently, in a step ST19, the user selects the route along which the user has moved from among the candidate whole routes R31 to R33. The touch panel 50 detects the selection operation, and the operation information is input to the route correction unit 114. In a step ST20, the route correction unit 114 determines the selected candidate whole route as the whole route R10 and updates the route information. Then, the display controller 113 displays the whole route R10 based on the updated route information. FIG. 21 is a view schematically illustrating one example of the screen of the display 30, and schematically illustrates one example of a display screen 100i at the time of selecting the candidate whole route R31. In the exemplification of FIG. 21, a part not changed between before and after the correction and a part changed by the correction are illustrated in different display forms. Those parts may be displayed in the same display form.

According to the second embodiment, the correction of the whole route is received when the difference between the whole distances D1 and D2 is large, so that the correction of the whole route can be received when the correction is likely to be needed. In contrast, when the difference between the whole distances D1 and D2 is small, there is no need to receive the correction. In the above case, a mistaken correction operation can be suppressed. For example, it can be suppressed that the user accidentally selects the “correct” button 102g and the route processing unit 100 thereby starts the correction operation.

### Third Embodiment

The electronic apparatus 1 and the controller 10 according to the third embodiment have configurations similar to those of the first embodiment. In the third embodiment, both of the first and second embodiments are performed.

That is to say, the route generation unit 112 distinguishes between the first section route and the second section route and generates the route information in a manner similar to the first embodiment. The distance calculation unit 115 calculates the section distance corresponding to the first section route based on the information different from the current position information in a manner similar to the first embodiment and calculates, based on the second embodiment, the whole distance D2 based on the route information and the whole distance D1 based on the information different from the current position information.

The display controller 113 displays the whole route in which the first section route and the second section route are displayed in the different display form in a manner similar to the first embodiment and also displays the “correct” button together with the whole distances D1 and D2 when the difference between the whole distances D1 and D2 is larger than the error reference value in a manner similar to the second embodiment. FIG. 22 is a view schematically illustrating one example of the screen of the display 30, and schematically illustrates one example of a display screen 100j in the third embodiment. In the exemplification of FIG. 22, the display controller 113 displays the whole route R10 while distinguishing between the first section route and the second section route and also displays the whole distances D1 and D2 and the “correct” button 102g.

The subsequent operation is similar to that of each of the first and second embodiments, so that the repetitive description is omitted.

As a modification example of the third embodiment, the display controller 113 may initially display the whole route without distinguishing between the first section route and the second section route as shown in FIG. 16. Then, as described in the second embodiment, the display controller 113 displays the “correct” button 102g as shown in FIG. 18 when the difference between the whole distances D1 and D2 is larger than the error reference value. Upon reception of the selection operation of the button 102g, the display controller 113 may display the whole route while distinguishing between the first section route and the second section route (refer to FIG. 9).

When the user selects the first section route, it is also applicable to perform the correction operation on the first section route in a manner similar to the first embodiment.

The electronic apparatus 1 may keep the “correct” button 102g displayed in a state where the whole route is displayed while distinguishing between the first section route and the second section route. When the button 102g is selected again, the electronic apparatus 1 may perform the correction operation on the whole route as described in the second embodiment. Alternatively, the electronic apparatus 1 may include a button other than the “correct” button 102g and perform the correction operation on the whole route described in the second embodiment when the touch panel 50 detects the selection operation of this button.

### Fourth Embodiment

The electronic apparatus 1 and the controller 10 according to the fourth embodiment have configurations similar to those of the first embodiment. In the fourth embodiment, it is determined whether or not the correction on the first section route is received based on a difference between the section distance corresponding to the first section route generated based on the information other than the current position information and the distance of the first section route calculated based on the route information. The detail is described hereinafter.

Firstly, the distance calculation unit 115 calculates the section distance (a section distance D10 hereinafter) corresponding to the first section route based on the information other than the current position information in a manner similar to the first embodiment. This can be obtained by the operation shown in FIG. 8, for example. Furthermore, the distance calculation unit 115 also calculates a distance of the first section route (referred to as a distance D11 hereinafter) based on the current position information. For example, the distance D11 is calculated by appropriately integrating the road length of the link data constituting the first section route, for example.

When the section distance D10 and the distance D11 are substantially equal to each other, it can be estimated that the first section route is correctly generated. Accordingly, in the step ST5 in FIG. 5, the display controller 113 may display the whole route without distinguishing between the first section route and the second section route when the difference between the section distance D10 and the distance D11 is smaller than the error reference value, and display the whole route while distinguishing between the first section route and the second section route when the difference between the section distance D10 and the distance D11 is larger than the error reference value.

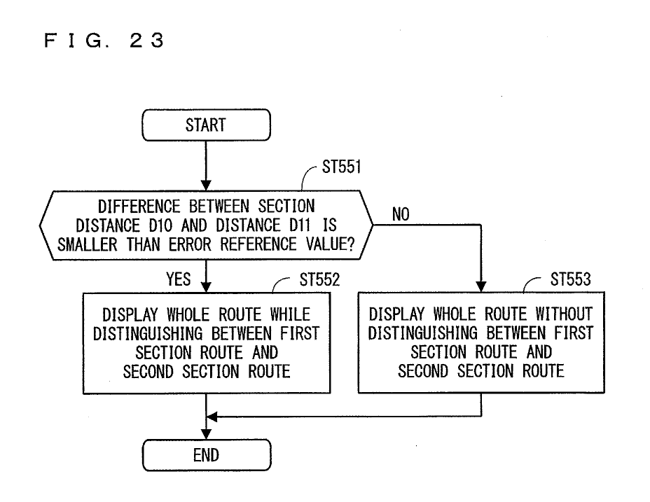

FIG. 23 is a flow chart illustrating one example of the operation of the display controller 113. In a step ST551, the determination unit 111 determines whether or not the difference between the section distance D10 and the distance D11 is larger than the error reference value. When a negative determination is made, the display controller 113 displays the whole route without distinguishing the first section route and the second section route in a step ST553. FIG. 16 shows the display screen of the above case, for example. At this time, the route correction unit 114 does not have to perform the correction operation of the first section route even when the user selects the first section route.

In the meanwhile, when the section distance D10 and the distance D11 are substantially different from to each other, there is a possibility that the first section route is not correctly generated. Accordingly, when a positive determination is made in the step ST551, that is to say, when the difference between the section distance D10 and the distance D11 is larger than the error reference value, the display controller 113 displays the whole route while distinguishing between the first section route and the second section route (refer to FIG. 9). In the above case, the route correction is performed in a manner similar to the first embodiment.

As described above, when the difference between the section distance D10 and the distance D11 is large, the first section route and the second section route are displayed in the display form different from each other. Accordingly, when the route is likely to be generated mistakenly, the user can easily confirm the first section route. In contrast, when the difference between the section distance D10 and the distance D11 is small, the route is likely to be generated correctly, and in the above case, the user's confirmation of the first section route is not promoted, so that the unnecessary confirmation operation performed by the user can be suppressed.

In a manner similar to the second embodiment, when the difference between the section distance D10 and the distance D11 is larger than the predetermined value, the display 30 may display the values of the section distance D10 and the distance D11.

### Fifth Embodiment

The electronic apparatus 1 and the controller 10 according to the fifth embodiment have configurations similar to those of the second embodiment. In the fifth embodiment, the section route to be corrected is optionally set by an input operation performed by the user. That is to say, the user performs the input operation to designate at least a part of the whole route (the section route to be corrected) on the input unit (for example, the touch panel 50). This point is described in detail hereinafter.

When the user moves, the route generation unit 112 generates the route information without distinguishing between the first section route and the second section route, for example, in a manner similar to the second embodiment.

The distance calculation unit 115 calculates a distance corresponding to each point based on information different from the current position information. For example, in a manner similar to the first embodiment, the number of steps corresponding to each point is measured and the number of steps is multiplied by the distance per step, so that the distance corresponding to the route from the starting point to each point of the whole route, for example. However, the above distance does not always coincide with the distance of the route. The reason is that when the acquisition accuracy of the current position acquiring unit is low, the route may be different from the route along which the user has actually moved.

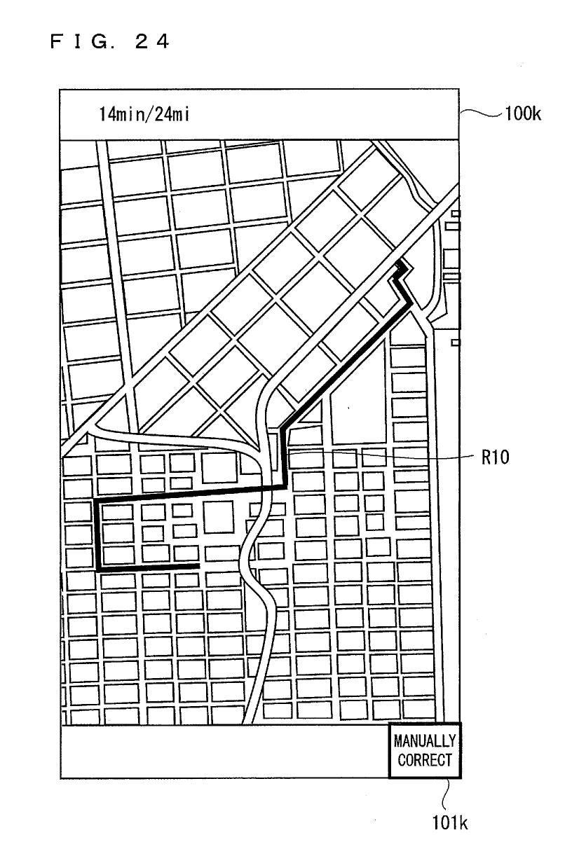

The display controller 113 displays the whole route on the display 30 based on the generated route information. FIG. 24 is a view schematically illustrating one example of the screen of the display 30, and schematically illustrates one example of a display screen 100k in which the whole route R10 is displayed. According to the exemplification of FIG. 24, the display controller 113 displays the whole route on the display 30 without distinguishing between the first section route and the second section route. According to the exemplification of FIG. 24, the display controller 113 displays a “manually correct” button 101k on the display 30.

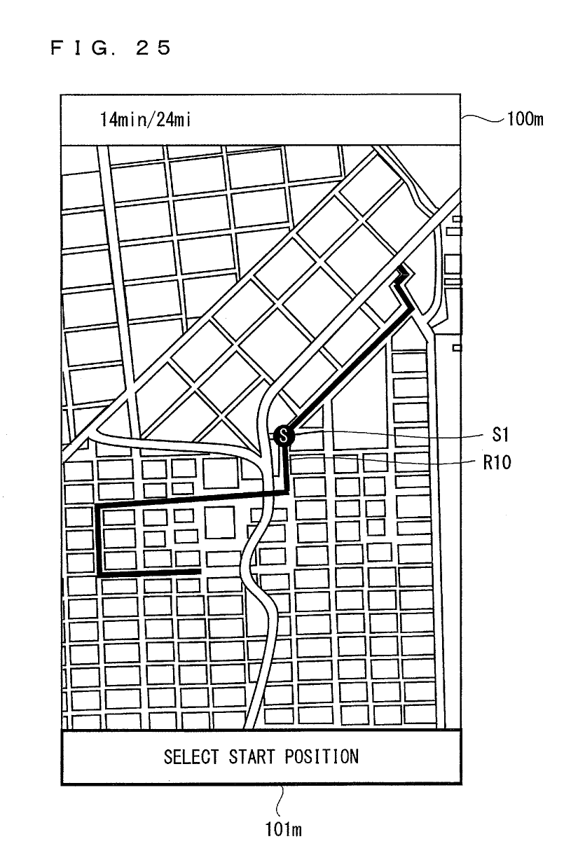

When it is determined that the whole route R10 is not correct, the user selects the “manually correct” button 101k. The touch panel 50 detects the selection operation, and the operation information is input to the route correction unit 114. The route correction unit 114 receives an input operation of designating the section route to be corrected in response to the operation information. At this time, as illustrated in FIG. 25, the route correction unit 114 may display a sentence 101m for promoting an input of the starting point on the display 30.

The user brings the operator close to or in contact with the starting point of the section route to be corrected on the displayed map, for example. The touch panel 50 detects the point which the operator gets close to or comes in contact with and then outputs the point to the route correction unit 114. The route correction unit 114 determines the point as the starting point, for example, and displays a symbol S1 indicating the starting point in the map on the display 30, for example.

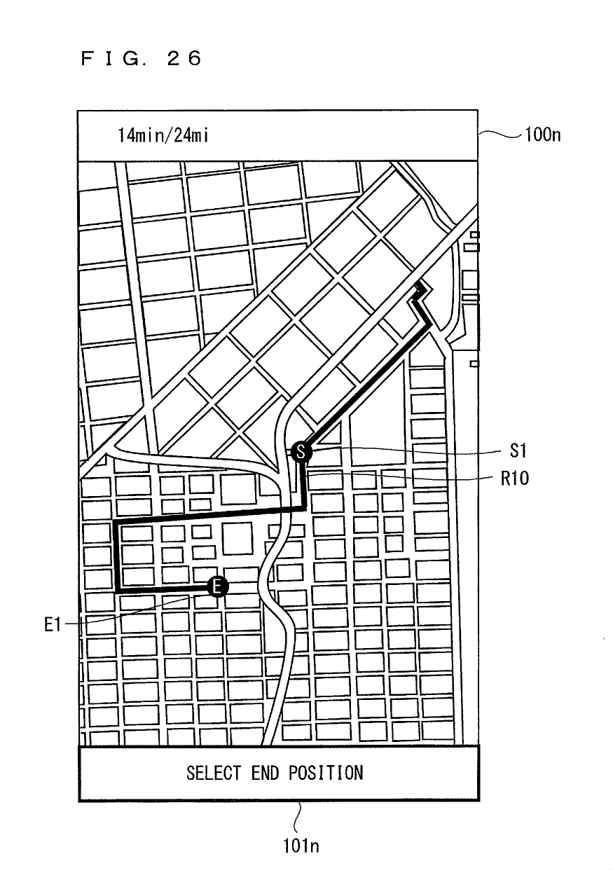

Subsequently, the route correction unit 114 receives an input operation of the ending point of the section route to be corrected. As exemplified in FIG. 26, the route correction unit 114 may also display a sentence 101n for promoting an input of the ending point on the display 30.

The user brings the operator close to or in contact with the ending point on the displayed map, for example. The touch panel 50 detects the point which the operator gets close to or comes in contact with and then outputs the point to the route correction unit 114. The route correction unit 114 determines the point as the ending point and displays a symbol E1 indicating the ending point in the map on the display 30, for example.

Subsequently, the route correction unit 114 extracts plurality of route connecting the starting point S1 and the ending point E1 from the map information.

The route correction unit 114 calculates a section distance corresponding to the section route from the starting point S1 to the ending point E1. This section distance indicates a difference of distances corresponding to the ending point E1 and the starting point S1, respectively, generated by the distance calculation unit 115. Then, applied as a candidate section is a route having a distance in which a difference between the distance and the section distance is smaller than the distance difference reference value in the plurality of the route. Accordingly, only the route along which the user is likely to have moved actually is displayed as the candidate section route.

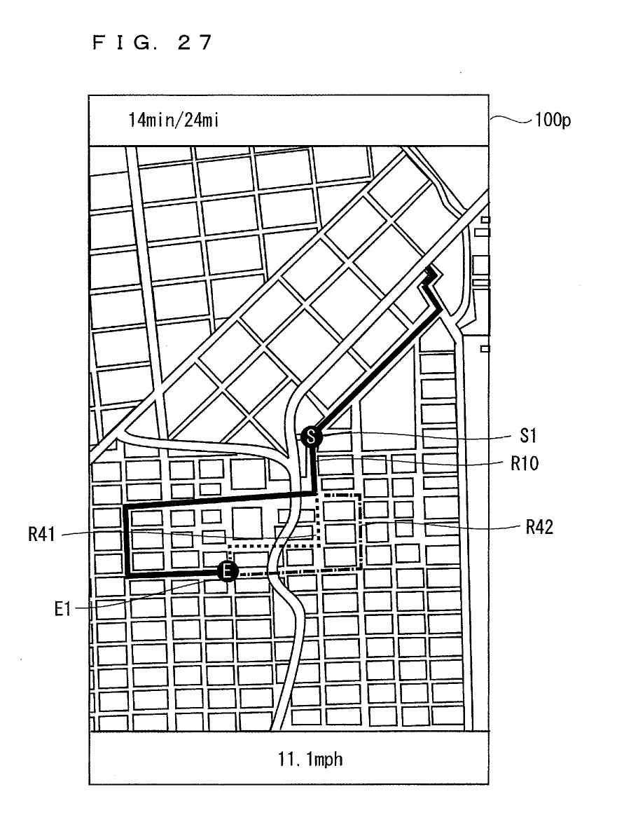

FIG. 27 is a view schematically illustrating one example of the screen of the display 30, and schematically illustrates one example of a display screen 100p in which candidate section routes R41 and R42 are displayed. The user selects the route along which the user has actually moved from the candidate section routes R41 or R42. For example, the user selects the candidate section route R41. The touch panel 50 detects the selection operation, and the operation information is input to the route correction unit 114. The route correction unit 114 replaces the route from the starting point S1 to the ending point E1 with the candidate section route R41 to update the route information.

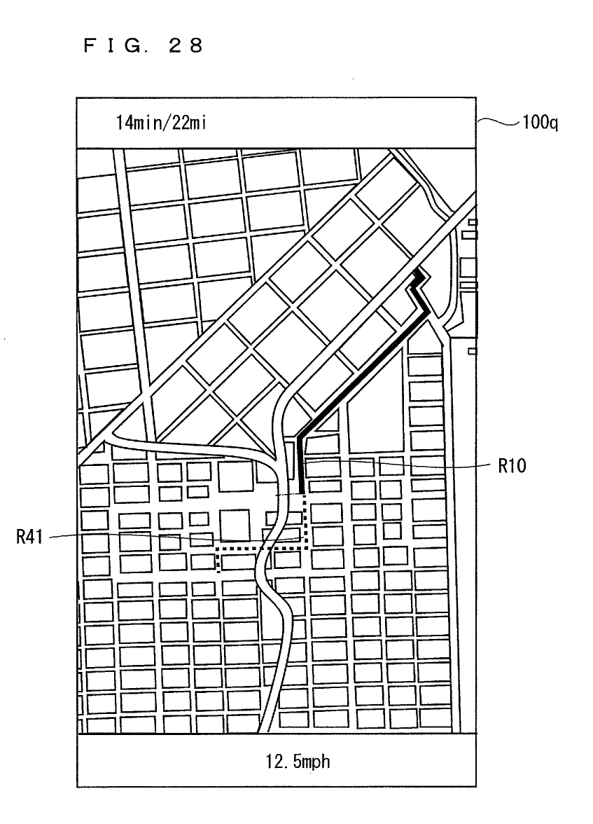

The display controller 113 displays the whole route R10 based on the updated route information. FIG. 28 is a view schematically illustrating one example of the screen of the display 30, and schematically illustrates one example of a display screen 101q in which the updated whole route R10 is displayed. In the exemplification of FIG. 28, the candidate section route R41 is displayed as a part of the whole route R10.

As described above, according to the fifth embodiment, the user can optionally designate the section route to be corrected, so that a detailed correction can be achieved.

The fifth embodiment can be combined with the first to fourth embodiments. For example, also in the first embodiment, the display controller 113 may display the “manually correct” button 102g. Then, the route processing unit 100 may perform the operation described above in response to the selection operation of the button 102g. Accordingly, an optional route other than the first section route can be corrected.

### Sixth Embodiment

In the first to fifth embodiments, the distance calculation unit 115 calculates the distance based on the information of the acceleration rate detected by the acceleration sensor. Then, the candidate of the route is selected in the condition based on this distance.

The distance calculated based on the route information may be calculated without consideration for a height. For example, when the distance between each point is calculated based on information of latitude and longitude in each point based on the route information, the height is not considered. In contrast, the distance obtained based on the acceleration sensor is a value obtained in consideration of the height.

When they are compared to select the route candidate, it is not preferable that one distance includes the height information and the other distance does not include the height information. Accordingly, proposed in in the sixth embodiment is a reduction in the difference of a distance caused by a presence or absence of the height information.

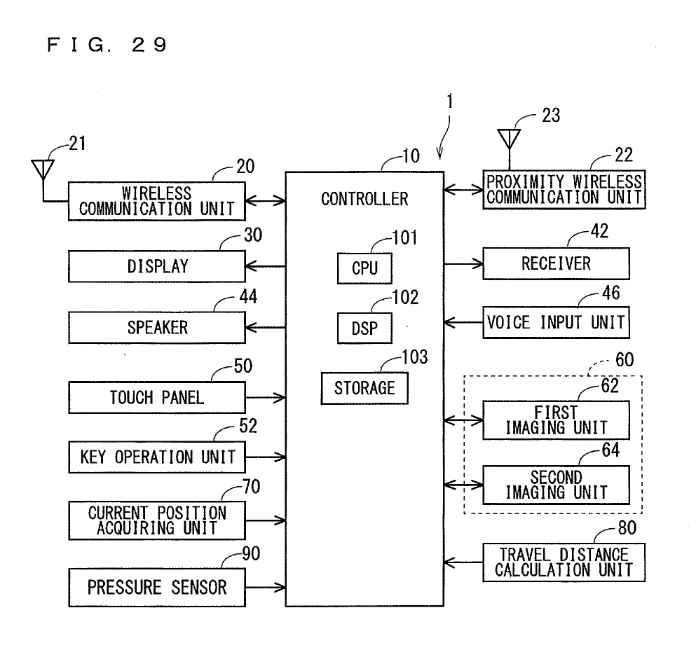

FIG. 29 is a view schematically showing one example of an electrical internal configuration of an electronic apparatus according to the sixth embodiment. A pressure sensor 90 is further provided in the sixth embodiment. The pressure sensor 90 detects an atmospheric pressure. The atmospheric pressure generally decreases with an increase of distance from the ground. It can be estimated that there is a little variation in a distribution of the atmospheric pressure in a short time. Accordingly, it can be estimated that a difference between the atmospheric pressure at the time of starting the movement and the atmospheric pressure in each point indicates the height of each point.

The distance calculation unit 115 therefore corrects the distance corresponding to the section route based on the atmospheric pressure detected by the pressure sensor 90. More specifically, the distance calculation unit 115 corrects the distance to get smaller with an increase of absolute value of the difference between the atmospheric pressures. Accordingly, the section distance can be calculated while suppressing a variation caused by the height. One example of the specific operation is described hereinafter.

When the user starts moving, the distance calculation unit 115 starts counting the number of steps using the pedometer 81, for example, and detects the atmospheric pressure (the initial atmospheric pressure) using the pressure sensor 90. Subsequently, the distance calculation unit 115 stores the number of steps corresponding to each point and also stores the atmospheric pressure in each point.

The distance calculation unit 115 performs a correction in a height direction on a value obtained by multiplying the number of steps in each point by the distance per step to calculate the distance between each point. Assumed herein is that the number of steps and the atmospheric pressure are stored corresponding to a first point to an N point between the starting point and ending point in the section route. Firstly, the distance per step is multiplied by a difference between a total number of steps corresponding to a (k+1)^{th} point (k falls under a natural number of 1 to N−1) and a total number of steps corresponding to a k^{th} point to calculate a distance before the correction from the k^{th} point to the (k+1)^{th} point. Subsequently, the distance before the correction is corrected so that the distance gets smaller with an increase of absolute value of the difference between an atmospheric pressures corresponding to the (k+1)^{th} point and an atmospheric pressure corresponding to the k^{th} point to calculate a distance from k^{th} point to the (k+1)^{th} point.

For example, a predetermined value is multiplied by the absolute value of the difference between the atmospheric pressures to calculate the correction value. Next, the distance before the correction is divided by the correction value to calculate the distance from k^{th} point to the (k+1)^{th} point. Subsequently, the value of k is changed and the distance is integrated to calculate the section distance corresponding to the section route. Accordingly, the distance in which the variation caused by the height is reduced can be calculated.

The route correction unit 114 extracts each route connecting the starting point and ending point of the section route from the map information to calculate the distance of the route based on the map information. Herein, the distance does not include the height information. Then, the route having a distance in which a difference between the distance and the section distance is smaller than the distance difference reference value is applied as a candidate replaced with the section route.

As described above, the distances can be compared while suppressing the difference of the distance caused by the height information, so that the candidate replaced with the section route can be selected with a higher degree of accuracy.

The above-mentioned description is illustrative in all aspects and embodiments are not intended to be limited thereto. Various modifications not exemplified are construed to be made without departing from the scope of the present application.

Embodiments can be implemented in combination as long as they are not mutually inconsistent.

1. An electronic apparatus, comprising:
a wireless communication unit;
a display;
a position acquiring unit configured to obtain a position information of the electronic apparatus based on a received signal received by the wireless communication unit; and
at least one processor configured to
(i) generate a whole route along which a user has moved based on a plurality of position information while distinguishing between a first section route and a second section route other than the first section route, the first section route being a route in which an acquisition accuracy of the position information is lower than a reference value,
(ii) obtain a section distance from a starting point to an ending point of the first section route based on a predetermined information different from a position information,
(iii) generate a candidate section route, which is different from the first section route, for connecting the starting point and the ending point of the first section route based on the section distance, and
(iv) display the first section route, the second section route, and the candidate section route on the display.

2. The electronic apparatus according to claim 1, further comprising:
a pedometer configured to include an acceleration sensor and obtain a total number of steps based on the acceleration sensor, wherein
the predetermined information comprises the number of steps obtained by the pedometer, and
the at least one processor obtains the section distance based on a difference between a total number of steps in a starting point of the first section route and a total number of steps in an ending point of the first section route.

3. The electronic apparatus according to claim 1, further comprising:
an input unit, wherein
when an input operation for selecting the candidate section route is received via the input unit in a state where the display displays the first section route, the second section route, and the candidate section route, the at least one processor finishes displaying the first section route.

4. The electronic apparatus according to claim 1, wherein
in a state where the display displays the first section route, the second section route, and the candidate section route, the at least one processor displays the first section route, the second section route, and the candidate section route in display forms different from each other.

5. The electronic apparatus according to claim 1, wherein
the at least one processor calculates a first whole distance which is a whole distance of the whole route based on a route information indicating the whole route,
obtains a second whole distance which is a whole distance of the whole route based on a predetermined information different from a position information,
obtains a candidate whole route, which is different from the whole route, for connecting a starting point and an ending point of the whole route based on the second whole distance when a difference between the first whole distance and the second whole distance is larger than a predetermined value, and
displays the whole route and the candidate whole route on the display.

6. The electronic apparatus according to claim 5, further comprising:
a pedometer configured to include an acceleration sensor and obtain a total number of steps based on the acceleration sensor, wherein
the at least one processor calculates the first whole distance based on said plurality of position information and a map information,
the predetermined information comprises the number of steps obtained by the pedometer, and
the at least one processor obtains the second whole distance based on a difference between a total number of steps in a starting point of the whole route and a total number of steps in an ending point of the whole route.

7. The electronic apparatus according to claim 5, wherein
when the difference between the first whole distance and the second whole distance is larger than the predetermined value, the at least one processor displays a value of the first whole distance and a value of the second whole distance on the display.

8. An electronic apparatus, comprising:
a wireless communication unit;
a display;
a position acquiring unit configured to obtain a position information of the electronic apparatus based on a received signal received by the wireless communication unit; and
at least one processor configured to
(i) generate a route information indicating a whole route along which a user has moved based on a plurality of position information,
(ii) calculate a first whole distance which is a whole distance of the whole route based on the route information,
(iii) obtain a second whole distance which is a whole distance of the whole route based on a predetermined information different from a position information,
(iv) obtain a candidate whole route, which is different from the whole route, for connecting a starting point and an ending point of the whole route based on the second whole distance when a difference between the first whole distance and the second whole distance is larger than a predetermined value, and
(v) display the whole route and the candidate whole route on the display.

9. The electronic apparatus according to claim 8, further comprising:
a pedometer configured to include an acceleration sensor and obtain a total number of steps based on the acceleration sensor, wherein
the at least one processor calculates the first whole distance based on said plurality of position information and a map information,
the predetermined information comprises the number of steps obtained by the pedometer, and
the at least one processor obtains the second whole distance based on a difference between a total number of steps in a starting point of the whole route and a total number of steps in an ending point of the whole route.

10. The electronic apparatus according to claim 8, wherein
when the difference between the first whole distance and the second whole distance is larger than the predetermined value, the at least one processor displays a value of the first whole distance and a value of the second whole distance on the display.

11. A control method of an electronic apparatus, comprising:
obtaining a position information of the electronic apparatus based on a received signal received by a wireless communication unit,
generating a whole route along which a user has moved based on a plurality of position information while distinguishing between a first section route and a second section route other than the first section route, the first section route being a route in which an acquisition accuracy of the position information is lower than a reference value,
obtaining a section distance from a starting point to an ending point of the first section route based on a predetermined information different from a position information
generating a candidate section route, which is different from the first section route, for connecting the starting point and the ending point of the first section route based on the section distance, and
displaying the first section route, the second section route, and the candidate section route on the display.
